(19) United States
(12) Patent Application Publication
(10) Pub. No.: US 2014/0301237 A1
(43) Pub. Date: Oct. 9, 2014

(54) METHOD FOR ACQUIRING INFORMATION ON OCCUPIED CHANNEL OF DEVICE WHICH SUBSCRIBES TO INFORMATION SERVICE IN TELEVISION WHITE SPACE BAND

(71) Applicant: LG ELECTRONICS INC., Seoul (KR)

(72) Inventors: Yunjung Yi, Anyang-si (KR); Eunsun Kim, Anyang-si (KR); Suhwook Kim, Anyang-si (KR)

(73) Assignee: LG ELECTRONICS INC., Seoul (KR)

(21) Appl. No.: 14/357,135

(22) PCT Filed: Nov. 8, 2012
(86) PCT No.: PCT/KR2012/009382

§ 371 Date: May 8, 2014

Related U.S. Application Data
(60) Provisional application No. 61/556,828, filed on Nov. 8, 2011.

(51) Int. Cl. H04W 24/10

(52) U.S. Cl. CPC H04W 24/10
USPC 370/252

(57) ABSTRACT

Provided is a method for acquiring information on an occupied channel of an apparatus (hereinafter, “information service apparatus”) which subscribes to an information service in order to allocate a channel to an apparatus (hereinafter, “management service apparatus”), which is performed by a management apparatus, and comprises: transmitting, to the information service apparatus, an occupied channel query request message for query of information about one or more channels (hereinafter, “occupied channels”) occupied by the information service apparatus; and receiving, from the information service apparatus, an occupied channel query response message including the information about the occupied channels, wherein the occupied channel query request message includes an ID of the information service apparatus and information about a measurement period of the occupied channels, and the information service apparatus and the management service apparatus may be TVWS devices.

### TECHNICAL FIELD

The present invention relates to a method for acquiring occupied channel information of an apparatus that subscribes an information service in a television whitespace (TVWS) band.

### BACKGROUND ART

Conventionally, frequency distribution for new services and frequency distribution to new service providers are lead by the government.

In particular, when there are new service providers, new frequencies are allocated via auction or the like or existing frequencies are revered from existing service providers and rearranged to new service providers so as to distribute frequencies as limited resources.

However, as recent explosive growth in radio data traffic has occurred due to spread of various Internet based applications such as an open type terminal platform, App store, mobile VoIP, etc., such frequency distribution lead by the government is very ineffective and it becomes more difficult to ensure new frequencies on a frequency distribution table basically.

In particular, along with rapid growth of broadcast and communication systems, a next-generation communication system is designed in the form of fusion of various networks and becomes more complex, and a need for coexistence is gradually expanded. Along with the development of communication technologies and services, as frequency of usage of frequency resources increases and specific frequency bands are fixedly occupied in order to provide excellent communication technologies and services, frequency exhaustion issues are in a critical situation.

Recently, frequency sharing schemes have been proposed as a method for overcoming the above issues. Among the schemes, a technology for searching for idle resources (a spectrum hole or white space) that have a low frequency of usage and are not occupied from a temporal/spatial point of view among frequency bands allocated to an unlicensed band in a TV broadcast band and adaptively and opportunistically using the idle resources has been proposed. In this case, when a primary user having a license for a corresponding band is discovered, the primary user should not be interrupted by immediately stopping use of the corresponding band or adjusting transmit power. A system for frequency sharing using the idle resources is referred to as a television band device (TVBD) or television white space (TVWS) system, and networks or devices using shared frequency resources in the system are referred to as TVBD or TVWS networks or devices.

The TVBD or TVWS system provides largely two types of services. One is an information service and the other is a management service. The information service may provide the following functions.

1-A. Authentication/de-authentication): A coexistence manager (CM) performs authentication/de-authentication of the TVBD or TVWS networks or devices.

1-B. Registration/de-registration: A CM performs registration/de-registration of the TVBD or TVWS networks or devices to a server.

1-C. NeighborReport: A CM responds with a set of neighboring TVBD networks or devices upon receiving NeighborReport request from a coexistence enabler (CE). The response includes neighboring CM IDs and information of neighboring TVBD networks or devices registered to those neighboring CMs.

1-D. Acquisition of available channel list: A CM may acquire a list of available channels that each TVBD network or device has received from TVWS database.

The management service may provide the following functions.

2-A. Authentication/de-authentication: A CM performs authentication and de-authentication of the TVBD or TVWS networks or devices.

2-B. Registration/de-registration): A CM performs registration/de-registration of the TVBD or TVWS networks or devices to the server.

2-C. NeighborReport: A CM responds with a set of neighboring TVBD networks or devices upon receiving NeighborReport request from a CE. The response includes neighboring CM IDs and information of neighboring TVBD networks or devices registered to those neighboring CMs.

2-D. Acquisition of available channel list: A CM may acquire a list of available channels that each TVBD network or device has received from TVWS database.

2-E. Acquisition of information: A CM may request a CE for information about a desired bandwidth, desired occupancy, desired QoS, desired coverage, etc. The acquired information can be used in a coexistence decision making process.

2-F. Request and acquisition of measurement: A CM may request TVBD or TVWS networks or devices registered thereto to acquire measurement report. In addition, the CM can also request TVBD or TVWS networks or devices to perform measurements.

2-G. Reconfiguration request to CE: A CM may request TVBD or TVWS networks or devices to change operating frequency, transmission power limit, transmission schedule, etc.

2-H. Resource allocation request from CE: A CE may request to allocate resources (e.g., channel number, start/end frequency, maximum power level, expected throughput, etc.).

2-I. Event indication from CE: A CE may send indication to a CM for notification of an even that has occurred. The event includes an event in which a signal to interference plus noise ratio (SINR) reaches a threshold, an even in which QoS degradation occurs, detection of mislocated TVBD or TVWS networks or devices, etc.

A CM may provide the following functions irrespective of services.

3-A. CM information/neighbor list exchange and negotiation: A CM may exchange a neighbor list or information obtained from TVBD or TVWS networks or devices registered to the CM with other CMs. A CM may also negotiate with other CMs to improve coexistence decision making process (e.g., increase in the probability of finding available channels for TVBD or TVWS networks or devices registered to the CM).

3-B. CM Reconfiguration: A CM may request another CM to reconfigure its resource (e.g., operating frequency, transmission power limit, channel sharing, channel sharing schedule, etc.).

### DISCLOSURE

### Technical Problem

An object of the present invention devised to solve the problem lies in management of all TVBD networks and devices that subscribe an information service and a management service by a management apparatus. In more detail, the present invention provides a mechanism for estimation or measurement of an interference or load level of TVBD networks or devices that subscribe an information service and for providing the estimation or measurement result for channel allocation for TVBD networks or devices that subscribe a management service.

### Technical Solution

The object of the present invention can be achieved by providing a method for acquiring information about an occupied channel of an apparatus (hereinafter, an information service apparatus) subscribing an information service for channel allocation for an apparatus (hereinafter, a management service apparatus) subscribing a management service in a television white space (TVWS) network in which the information service apparatus and the management service apparatus coexist, the method being performed by a management apparatus, the method including transmitting an occupied channel query request message for query of information about one or more channels (hereinafter, occupied channels) occupied by the information service apparatus, to the information service apparatus, and receiving an occupied channel query response message including the information about the occupied channels, from the information service apparatus, wherein the occupied channel query request message includes an identification (ID) of the information service apparatus and information about a measurement period of the occupied channels, and the information service apparatus and the management service apparatus are TVWS apparatuses.

Preferably, the occupied channel query response message may include an ID of the information service apparatus, the number of the occupied channels, a list of the occupied channels, a maximum power list of each of the occupied channels, and a channel busy time of each of the occupied channels.

Preferably, the method may further include receiving a neighbor report request message for requesting information about at least one neighbor management service apparatus, from the information service apparatus, and transmitting a neighbor report response message including information about the at least one neighbor management service apparatus, acquired via measurement report from the at least one neighbor management service apparatus, to the information service apparatus, wherein the information about the at least one neighbor management service apparatus may include at least one of information about a channel or frequency occupied by the at least one neighbor management service apparatus, and information about a position of the neighbor management service apparatus, and the information about the at least one neighbor management service apparatus may be used to select a channel to be occupied by the information service apparatus.

Preferably, the method may further include transmitting a measurement request message to at least one information service apparatus or management service apparatus registered to the management apparatus, and receiving a measurement report message from the at least one information service management or management service apparatus, wherein the measurement request message may include information about a measurement type and a measurement request according to the measurement type, and the measurement type may indicate measurement of an interference level, occupied channel information, an average noise power indicator (ANPI), a packet error rate (PER), channel load, neighbor discovery information, and threshold exceed interference load.

Preferably, when the measurement type indicates measurement of one of the interference level, the ANPI, the PER, and the channel load, information about the measurement request may include the information about a target channel or frequency for the measurement.

Preferably, when the measurement type may indicate measurement of the neighbor discovery, the information about the measurement request may include information about an ID of a neighbor CM and an occupied channel.

Preferably, when the measurement type may indicate measurement of the threshold exceed interference load, information about the measurement request may include information about a threshold and a target channel or frequency for the measurement.

Preferably, the measurement request message and the measurement report message may include an ID of the information service apparatus.

Preferably, the method may further include allocating a channel of the management service apparatus based on information about the occupied channels, contained in the occupied channel query response message.

Preferably, the ID of the information service apparatus may be a unique value of each information service apparatus allocated by a server, and the method may further include, upon receiving information about the information service apparatus registered to the management apparatus from another management apparatus, transmitting a response message including an ID of information service apparatus registered to the management apparatus to the another management apparatus.

In another aspect of the present invention, provided herein is a method for acquiring information about an occupied channel of an apparatus (hereinafter, an information service apparatus) subscribing an information service for channel allocation for an apparatus (hereinafter, a management service apparatus) subscribing a management service in a television white space (TVWS) network in which the information service apparatus and the management service apparatus coexist, the method being performed by an information service apparatus, the method including receiving an occupied channel query request message for query of information about one or more channels (hereinafter, occupied channels) occupied by the information service apparatus, from a management apparatus, and transmitting an occupied channel query response message including information about the occupied channels, to the management apparatus, wherein the occupied channel query request message includes an identification (ID) of the information service apparatus and information about a measurement period of the occupied channels, and the information service apparatus and the management service apparatus are TVWS apparatuses.

Preferably, the occupied channel query response message may include an ID of the information service apparatus, the number of the occupied channels, a list of the occupied channels, a maximum power list of each of the occupied channels, and a channel busy time of each of the occupied channels.

Preferably, the method may further include transmitting a neighbor report request message for requesting information about at least one neighbor management service apparatus, to the management apparatus, and receiving a neighbor report response message including information about the at least one neighbor management service apparatus, acquired via measurement report from the at least one neighbor management service apparatus, from the management apparatus, wherein the information about the at least one neighbor management service apparatus may include at least one of information about a channel or frequency occupied by the at least one neighbor management service apparatus, and information about position of the neighbor management service apparatus, and the information about the at least one neighbor management service apparatus may be used to select a channel to be occupied by the information service apparatus.

Preferably, the ID of the information service apparatus may be a unique value of each information service apparatus allocated by a server, and upon receiving a request for information about the information service apparatus registered to the management apparatus from another management apparatus, a response message including an ID of the information service apparatus is transmitted by the management apparatus to the another management apparatus.

It is to be understood that both the foregoing general description and the following detailed description of the present invention are exemplary and explanatory and are intended to provide further explanation of the invention as claimed.

### Advantageous Effects

According to an embodiment of the present invention, interference estimation or calculation can be easily performed on television whitespace (TVWS) networks or devices (or a WSO) that subscribe an information service in a TVWS network or band.

In addition, identification information about TVWS networks or devices (or a WSO) that subscribe another CM.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a block diagram illustrating a coexistence system according to an embodiment of the present invention;

FIG. 2 is a block diagram illustrating a coexistence system according to another embodiment of the present invention;

FIG. 3 is a diagram illustrating an example of arrangement of a coexistence system according to an embodiment of the present invention;

FIG. 4 illustrates an operation of a coexistence system according to an embodiment of the present invention;

FIG. 5 is a diagram illustrating another example of arrangement of a coexistence system according to an embodiment of the present invention;

FIG. 6 is a diagram illustrating an example of an operation of CDIS/CDB;

FIG. 7 is a diagram illustrating an example of a coexistence contour;

FIG. 8 illustrates an example of a coexistence whitespace map (CWM) or a coexistence map in the environment of FIG. 7;

FIG. 9 is a diagram for explanation of a process of receiving occupied channel information and interference level information from a TVBD network or device by a CM according to an embodiment of the present invention;

FIG. 10 is a diagram for explanation of a process of receiving occupied channel information and interference level information from a TVBD network or device by a CM according to another embodiment of the present invention

FIG. 11 is a diagram for explanation of a process of discovering a neighbor set of a TVBD network or device by a CM according to an embodiment of the present invention;

FIG. 12 is a diagram illustrating a service changing process of a TVBD network or device or a CM according to an embodiment of the present invention;

FIG. 13 is a diagram illustrating a service changing process of a TVBD network or device or a CM according to another embodiment of the present invention;

FIG. 14 is a diagram illustrating a service selection process of a TVBD network or device according to another embodiment of the present invention;

FIG. 15(a) is a diagram illustrating semantics of a service primitive of coexistence service changing request according to an embodiment of the present invention;

FIG. 15(b) is a diagram illustrating semantics of a service primitive of coexistence service changing indication according to an embodiment of the present invention;

FIG. 15(c) is a diagram illustrating semantics of a service primitive of a coexistence service changing response according to an embodiment of the present invention;

FIG. 15(d) is a diagram illustrating semantics of a service primitive of coexistence service changing confirmation according to an embodiment of the present invention;

FIG. 16 is a diagram illustrating a service changing process of a CM according to an embodiment of the present invention;

FIG. 17 is a message flowchart for estimation of interference according to an embodiment of the present invention;

FIG. 18 is a message flowchart for interference estimation according to an embodiment of the present invention;

FIG. 19 illustrates a type of interference to a TVWS and an estimating method for the interference; and

FIG. 20 is a block diagram of a TVWS network or device according to an embodiment of the present invention.

### BEST MODE

The terminology used herein is for the purpose of describing particular embodiments only and is not intended to be limiting of the present invention. Unless otherwise defined, all technical terms used herein have the same meaning as commonly understood by one of ordinary skill in the art to which this present invention belongs and will not be interpreted in overly wide or narrow sense unless expressly so defined herein. If a term used herein is a wrong term by which one of ordinary skill in the art cannot correctly understand the present invention, the wrong term should be replaced by a technical term by which one of ordinary skill in the art can correctly understand the present invention. It will be further understood that terms, such as those defined in commonly used dictionaries, should be interpreted as having a meaning that is consistent with their meaning in the context of the relevant art and will not be interpreted in an overly narrow sense.

As used herein, the singular forms “a,” “an” and “the” are intended to include the plural forms as well, unless the context clearly indicates otherwise. It will be further understood that the terms “comprises” or “comprising” are not intended to included all elements or all steps described herein, but do not preclude exclusion of some elements or steps described herein or addition of one or more other elements or steps.

It will be understood that, although the terms first, second, third etc. may be used herein to describe various elements, these elements should not be limited by these terms. These terms are only used to distinguish one element from another element. For example, a first element may be termed a second element and a second element may be termed a first element without departing from the teachings of the present invention.

It will be understood that when an element is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements present.

Hereinafter, the present invention will be described in detail by explaining exemplary embodiments of the invention with reference to the attached drawings. The same reference numerals in the drawings denote like elements, and a repeated explanation thereof will not be given. In the description of the present invention, certain detailed explanations of related art are omitted when it is deemed that they may unnecessarily obscure the essence of the invention. The features of the present invention will be more clearly understood from the accompanying drawings and should not be limited by the accompanying drawings. It is to be appreciated that all changes, equivalents, and substitutes that do not depart from the spirit and technical scope of the present invention are encompassed in the present invention.

Hereinafter, the term ‘user equipment’ will be described but may be replaced with a user equipment (UE), a mobile equipment (ME), a mobile station (MS), a user terminal (UT), a subscriber station (SS), a mobile subscriber station (MSS), a wireless device, a handheld device, and an access terminal (AT).

Standards for IEEE 802.11 wireless local area network (WLAN) provide transmission rates of 11 Mbps (IEEE 802.11b) and 54 Mbps (IEEE 802.11a) using an unlicensed band at 2.4 GHz or 5 GHz.

IEEE 802.11g provides a transmission rate of 54 Mbps using orthogonal frequency-division multiplexing (OFDM) at 2.4 GHz.

IEEE 802.11n provides a transmission rate of 300 Mbps for 4 spatial streams using multiple input multiple output-orthogonal frequency division multiplexing (MIMO-OFDM). IEEE 802.11n supports channel bandwidths of up to 40 MHz and, in this case, provides a transmission rate of 600 Mbps.

TV whitespace is a frequency band including a VHF band (54 to 60, 76 to 88, and 174 to 216 MHz) and a UHF band (470 to 698 MHz) allocated to broadcast TV, in which use of an unlicensed device is allowed under a condition in which communication of licensed devices (TV broadcast, wireless microphone, etc.) that operate in a corresponding frequency band.

A TVWS is an abbreviation of a television white space. Here, TV white space refers to a vacant frequency band that is not used by a broadcaster in VHF and UHF frequency bands that are distributed for TV broadcast and refers to an unlicensed band that can be used by any user when he or she satisfies conditions of radio wave regulations of the government. In detail, the TV white space refers to a vacant band for prevention of frequency interference between broadcasters and a frequency band that is not used for each region or an area to which radio waves for broadcast do not reach for each region from a spatial point of view, and refers to a vacant broadcast frequency in a time zone when a broadcaster does not broadcast at dawn from a temporal point of view. A TV white space device should not interfere with a TV viewer as a customer of a broadcaster, should not interrupt reception, and should not affect a wireless microphone device that communicates with low power using a portion of the band.

In 512 to 608 MHz and 614 to 698 MHz, operations are allowed for all unlicensed devices except for in some particular cases, but bands 54 to 60 MHz, 76 to 88 MHz, 174 to 216 MHz, and 470 to 512 MHz, only communication between fixed devices is allowed. A fixed device is a device that performs transmission from a fixed location.

An IEEE 802.11 TVWS UE refers to an unlicensed device that operates using IEEE 802.11 MAC and PHY in a TV whitespace spectrum.

An unlicensed device that wants to use TV whitespace band needs to provide a licensed device protection function. Accordingly, the unlicensed device must check whether a licensed device occupies the corresponding TV band before starting transmission in the TV whitespace band.

To achieve this, the unlicensed device needs to access a geo-location database (GDB) through the Internet or a dedicated network to obtain information about a list of channels available in a corresponding area. The geo-location database stores and manages information about licensed devices registered therein and information about channels dynamically changed according to geo-locations of the licensed devices and time for which the licensed devices are used.

A station (STA) performs spectrum sensing mechanism. Examples of the spectrum sensing mechanism may include energy detection, feature detection, etc. When the intensity of a received signal is higher than a predetermined value, it is determined that an incumbent user is using TVWS or when a digital TV (DTV) preamble is detected, it is determined that an incumbent user is using TVWS. In addition, when it is determined that an incumbent user is using a channel immediately adjacent to the currently used channel, a STA and an access point (AP) need reduce transmit power.

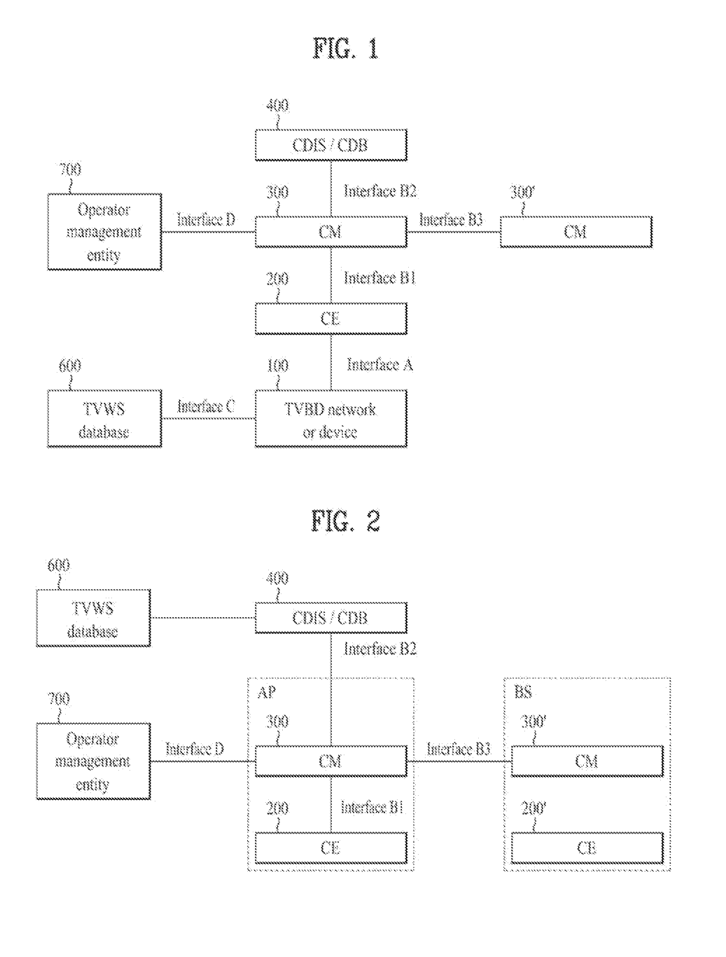

FIG. 1 is a block diagram illustrating a coexistence system according to an embodiment of the present invention.

In this specification, coexistence refers to the capability of two or more frequency (spectrum)-dependent devices or networks to operate without harmful interference. In addition, a coexistence service refers to a service provided to dissimilar or independently operated white space objects (WSOs) by a coexistence system and a service provided to other entities of the coexistence system by entities of the coexistence system. The WSO is an entity indicating a television white space (TVWS) device, a television band device (TVBD), a network of TVWS devices, or a TVBD network and is connected to a coexistence enabler for consumption of coexistence services.

In this specification, the TVWS device and the TVBD or TVBD device are interchangeable, and the TVWS network and the TVBD network are also interchangeable termed. In addition, TVBD or TVWS networks or devices are simply referred to as “TVBD (or TVWS) devices” and these correspond to an entity that can be referred to as a WSO.

As illustrated in FIG. 1, the coexistence system includes an coexistence enabler (CE) 200, a coexistence manager (CM) 300, and a coexistence discovery and information server (CDIS) or coexistence database (CDB) 400 according to function.

Here, the CE, the CM, and the CDIS or CDB may be installed or mounted on respective physical devices. Thus, each of these may be embodied as hardware using the devices on which these are installed or mounted. In order to clarify claims of the present invention, the CE, the CM, and the CDIS or CDB may be termed an apparatus or device in this specification including the claims. For example, the CM 300 may be termed a “management apparatus” and the CDIS 10 may be simply termed a “server”.

The CM 300 and the CE 200 are logical entities defined for coexistence between different wireless service providers or wireless systems that operate in an unlicensed state in a TVWS. The CM 300 is an object having an interface with a TVWS database and for resource allocation in order to overcome an issue associated with an interface between CEs 200 connected to the CM 300 while providing a guideline and policy associated with coexistence for coexistence between different service providers and systems operating in a TVWS.

The CE 200 is an entity that transmits command and information received from the CM 300 using an interface with a TVBD network or device 100 to the TVBD network or device 100. This specification describes a coexistence network structure in which STAs may perform a function of the CE 200 and a management entity such as the CM 300 is present as a higher entity for controlling a plurality of CEs 200. In general, the CE may be installed or mounted on the TVBD (or TVWS) network or device and may be contained therein. Thus, in this specification including the appended claims, the CE may also be referred to as “TVBD (or TVWS) network or device” or “TVBD (or TVWS) apparatus”.

The CE 200 receives commands or information associated with coexistence from the CM 300. The CE 200 converts the received information or commands into information or commands in the form of media specific form and transmits the converted information or commands to the TVBD network or device 100, for an operation of the TVBD network or device 100 which is requested by the corresponding message. Similarly, the CE 200 may convert the information received from the TVBD network or device 100 in the form of a message defined in the coexistence system and transmit the converted message to the CM 300. Since the CE 200 is disposed in the TVBD network or device 100, a service access point (SAP) and primitive with an management entity of the TVBD network or device 100 need to be defined in order to transmit information and command for coexistence.

The CM 300 may serve one or more CE 200. The CM 300 may acquire required information from another CM 300 or the CE 200 served by the CM 300 or an external entity such as a TVWS database. The CM 300 may receive and transmit information or a command message from and to another CM 300 or transmit information or commands to the CE 200 served by the CM 300. The CM 300 may perform coexistence decision making based on the acquired information. In this regard, the coexistence decision making may include determination of a maximum transmission power value and operation channel of the CE 300 served by the CM 300.

The TVBD network or device 100 may be a device or network of an unlicensed user who uses a TV band. For example, the TVBD network or device 100 may be a device operates in a master mode like an access point (AP) or a base station (BS). The TVBD network or device 100 may communicate with the CM 300 while operating in a master mode and manage/control devices that operate in a slave mode.

The CDIS 400 may have an interface with the CM 300 and acquire and manage information associated with the CM 300 served by the CDIS 400 and the CE 200 served by the corresponding CM 300, for example, geo-location information of the TVBD network or device 100 served by the CE 200 or available channel list information acquired from TVWS database by the TVBD network or device 100, a measurement result of the TVBD network or device 100, a list of the CE 200 served by the CM 300, etc. from the CM 300.

The CDIS 400 may calculate a neighbor relation between CMs 300 served by the CDIS 400 and between CEs 200. That is, in consideration of a specific TVBD network or device 100, the CDIS 400 may calculate a TVBD network or device 100 that interferes with the corresponding TVBD network or device 100 and a CE 200 and CM 300 served by the corresponding TVBD network or device 100.

In order to use a coexistence service, the CE 200 establishes connection with the CM 300 and registers the CE 200 to the corresponding CM 300. The CM 300 may also establish connection with a neighboring CM 300. The CM 300 manages CEs 200 registered to the CM 300 and provides a service for coexistence. Likewise, a topology in which the CM 300 performs decision making for coexistence while managing a plurality of CEs 200 is referred to as a centralized topology. A decision maker in the centralized topology is the CM 300 and thus the CE 200 operates according to decision making of the CM 300.

Hereinafter, each component in a coexistence system will be described in more detail.

The CE 200 is connected to the CM 300 via an interface B1, the CM 300 is connected to the CDIS or CDB 400 via an interface B2, and the CM 300 is connected to another CM 200 via an interface B3.

In addition, the CE 200 is connected to the TVBD network or device 100 via an interface A. Here, the TVBD network or device 100 refers to a user equipment for allowing use of a TV white space in the federal communication commission (FCC). The TVBD network or device 100 may be connected to the TVWS database 600 via an interface C.

The CE 200 may request and acquire information required for coexistence from the TVBD network or device 100, convert control information and reconfiguration change request/commands for received from the CM 300 into TVBD specific reconfiguration requests/commands, and transmit the TVBD specific reconfiguration requests/commands to the TVBD network or device 100.

In order to overcome a coexistence issue between TVBD networks, the CM 300 may have a function of discovering other CMs, a coexistence decision making function of generating and providing control information and coexistence request/command corresponding to the CE 300, and a function of supporting information exchange required for coexistence between CMs (which may include hierarchical or peer-to-peer decision making capabilities when CMs are arranged).

In addition, the CM 300 may have a function of selecting a master CM by sharing information between various CMs, a function of generating a coexistence whitespace map in order to effectively share frequency resources between different networks and systems as described later, and a function of helping network operates during management associated with TVWS coexistence.

The CM 300 may be embedded in a device such as an access point (AP) or a base station or may be installed out of the device.

The CDIS/CDB 400 may be represented as a CDIS or CDB according to a function. The CDIS/CDB 400 may have a function of generating a coexistence whitespace map or a coexistence map for effectively sharing frequency resources with other networks and systems, a function of controlling a plurality of operators during management associated with TVWS coexistence, and a function of selecting a master CM in order to reduce communication overhead between CMs and to overcome coexistence issues.

In addition, the CDIS/CDB 400 may perform a function of calculating a coexistence contour in order to discover neighboring networks/systems, a function of redirecting a coexistence whitespace map or a coexistence map according to a TVDB in order to coexistence issues, a function of boosting opening of an interface between CMs to support discovery of CMs, and a function of collecting, synthesizing, and providing information for boosting of coexistence (which includes data storage and data processing).

The CDIS/CDB 400 may omnipotently distribute resources for resource allocation, may suggest a criteria of priority between CMs 300 and control resource selection of each CM as an intermediary, or may function as a medium for sharing information between external and heterogeneous networks between CMs 300 as a DB.

The interface A may be an interface between the CE 200 and the TVBD network or device 100 and may be used to receive information required for coexistence, configuration/information request for coexistence, configuration/measurement/information response for coexistence, and other information as necessary from the TVBD network or device 100. Reconfiguration request/command and control information (corresponding to control information and coexistence request/command received from the CM), request/command associated with control of a measurement value, performed by the TVBD network or device 100, information indicating available resources, and other information as necessary from the CE 200 to the TVBD network or device 100.

The interface B1 may be an interface between the CE 200 and the CM 300 and may be used to provide information required for coexistence (information acquired from the TVBD network or device 100) and other information as necessary to the CM 300 from the CE 200. Coexistence request/command and control information and other information as necessary may be provided to the CE 200 from the CM 300.

The interface B2 may be an interface between the CM 300 and the CDIS/CDB 400 and may be used to provide information required for a coexistence map, information required for a neighbor set, information required for registration/unenrollment, information required for searching (which is acquired by a currently used CM), information required for coexistence, and information as necessary to the CDIS/CDB 400 from the CM 300.

Information indicated for a coexistence map, information indicated for a neighbor set (or a neighbor list) information indicated for a master CM, information required for search (which is acquired by another CM), information required for coexistence (which is acquired by another CM), and other information as necessary are provided to the CM 300 from the CDIS/CDB 400.

The interface B3 may be an interface between the CM 20 and another CM 300 and may be used to provide information and messages for discovery and coexistence, information indicated for registration/unregistration (to a master CM from a CM or to a server CM from a device CM), information indicated for a coexistence map (to a master CM from a CM or to a server CM from a device CM), information required for policy exchange/negotiation, and other information as necessary to another CM 300 from the CM 300.

The interface C may be an interface between the TVBD network or device 100 and the TVWS database 600 and may be used to provide information indicated for an available channel to the TVBD network or device 100 from the TVWS database 600.

The interface D may be an interface between the CM 300 and an operator management entity (OME) 700 and may be used to provide network operation information associated with information of the CM 300 (e.g., limiting factors associated with management of spectrum policy/network) and other information as necessary from the OME 700.

FIG. 2 is a block diagram illustrating a coexistence system according to another embodiment of the present invention.

As seen from FIG. 2, the CE 200 and the CM 300 may be embedded in an access point (AP) and a base station (BS), respectively.

In addition, the CDIS/CDB 400 may be connected to the TVWS database 600. Via this connection, the CDIS/CDB 400 may receive TV whitespace information from the TVWS database 600.

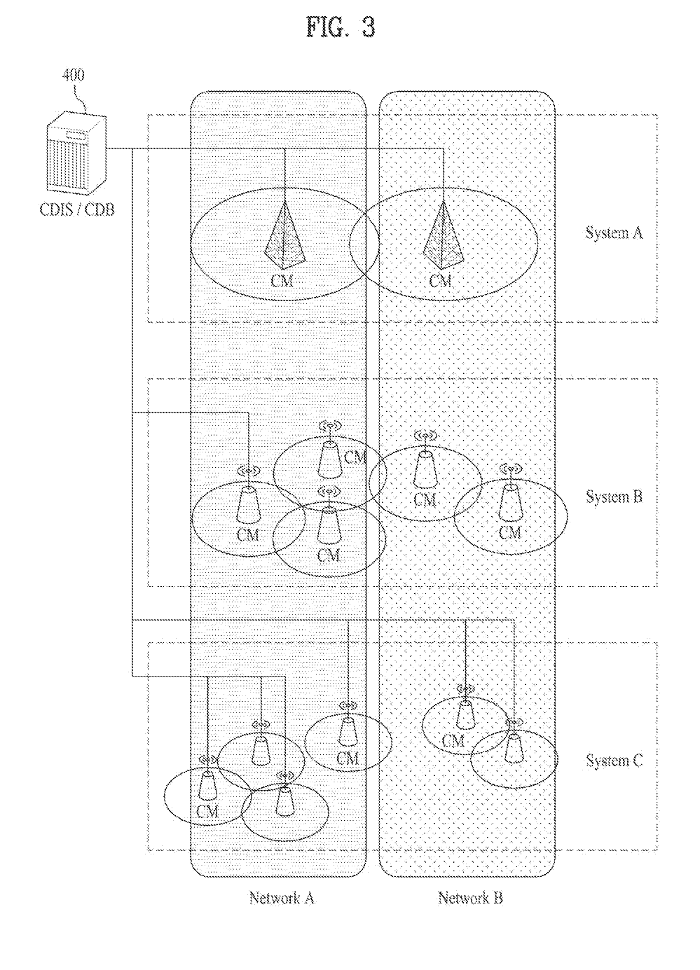

FIG. 3 is a diagram illustrating an example of arrangement of a coexistence system according to an embodiment of the present invention.

As seen from FIG. 3, a network A and a network B are vertically present. In addition, a communication system A, a communication system B, and a communication system C are horizontally present. The communication system A, the communication system B, and the communication system C may use different wireless access methods, that is, communication methods. For example, the communication system A may be a cellular communication system, for example, CDMA, GSM, CDMA-2000, WCDMA, LTE, LTE-Advanced, and IEEE 802.16. The system B may be a cellular system having cell coverage with a smaller size than the communication system A. Alternatively, the system B may be a system such as Wi-Fi. The system C may be a cellular system having cell coverage with a smaller size than the system B, for example, a femto cell. A CM is present for each of the communication system A, the communication system B, and the communication system C.

The communication system A, the communication system B, and the communication system C coexist geographically in the network A and also coexist geographically in the network B. For such coexistence, the CDIS/CDB 400 may generate a coexistence map and transmit the coexistence map to each CM.

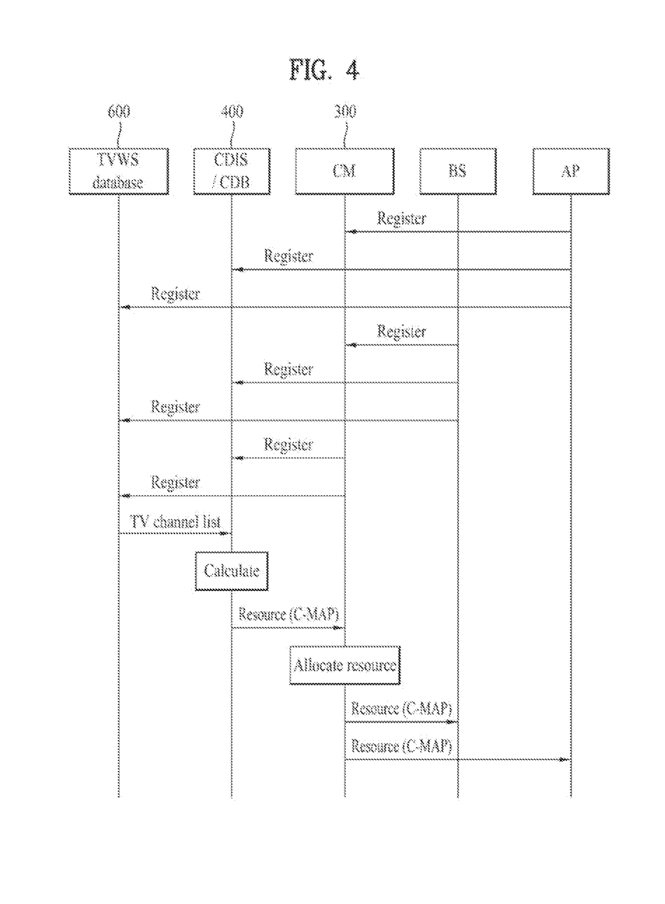

FIG. 4 illustrates an operation of a coexistence system according to an embodiment of the present invention.

As seen from FIG. 4, although the CM 300 is not embedded in an AP and a BS, this is purely exemplary. Thus, the CM 300 may be embedded in the AP and the BS. In addition, the CE 200 may be embedded in the AP and the BS.

The AP and the BS are each registered to the CM 300, the CDIS/CDB 400, and the TVWS database 600.

The CM 300 is also registered to the CDIS/CDB 400 and the TVWS database 600.

The CDIS/CDB 400 may receive a channel list for broadcast from the TVWS database 600. The channel list may be frequency information for broadcast. The channel list may include information about transmit power limitation and operating channel of broadcast.

The CDIS/CDB 400 checks whether the BS and the AP coexist in a random area using available channel information and position information of the BS and AP. When the BS and the AP coexist in the random area, the CDIS/CDB 400 may calculate a radius of coverage of the AP and the BS, allocate one or more frequency bands or a channel (or resource) available by different types of access points positioned in the random area, that is, the AP and the BS, based on the channel list, that is, the frequency information for broadcast, and generate and transmit information about the channel (or resource) and band, for example, a coexistence map.

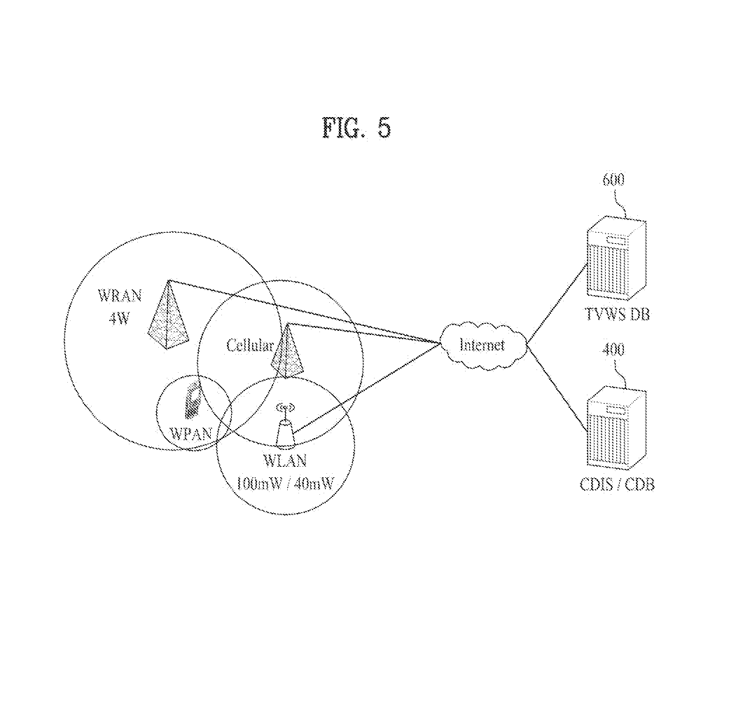

FIG. 5 is a diagram illustrating another example of arrangement of a coexistence system according to an embodiment of the present invention.

As seen from FIG. 5, the CM or CSIS/CDB 400 may operate such that plural APs coexist on a wireless communication system. The plural APs may be connected to the CDIS/CDB 400 using physical access such as the Internet.

The CDIS/CDB 400 may acquire channel information for broadcast from the TVWS database 600, as described above. In addition, the CDIS/CDB 400 may acquire channel information for broadcast in a specific geographic area, for example, a broadcast channel set. In addition, the CDIS/CDB 400 may calculate a coexistence contour. In particular, the CDIS/CDB 400 may have a neighbor discovery function on other systems that operate in a TV broadcast whitespace or TV broadcast frequency.

The CDIS/CDB 400 may generate a coexistence whitespace or a coexistence map as described above. The CDIS/CDB 400 may provide common clock information. In addition, the CDIS/CDB 400 may provide information for time synchronization between different systems.

The CDIS/CDB 400 may provide a parameter about a wireless range and interference range of each apparatus. The CDIS/CDB 400 may provide a parameter about the aforementioned coexistence contour. The CDIS/CDB 400 may identify neighboring network apparatuses for coexistence between different systems. The CDIS/CDB 400 may provide information about transmit capability of each network, an antenna height, and other physical parameters.

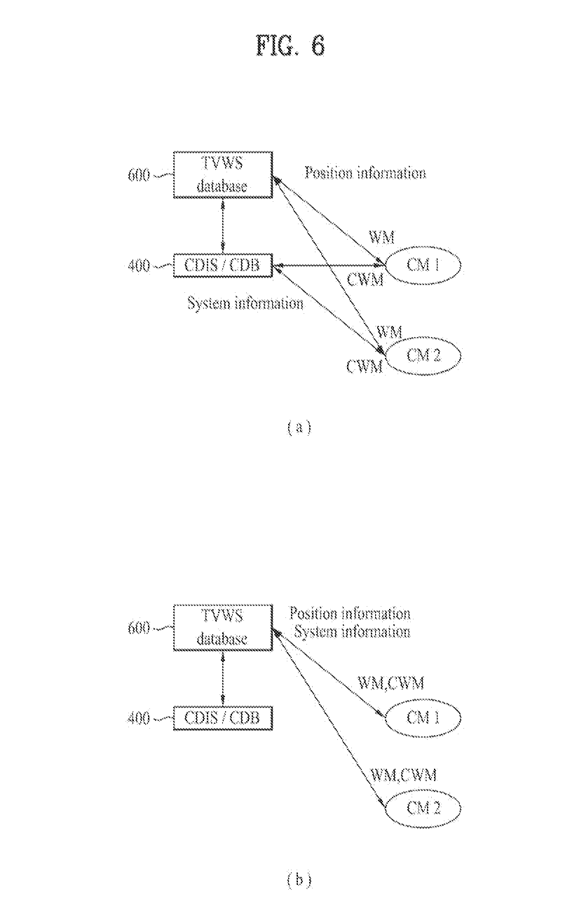

FIGS. 6(a) and 6(b) illustrate an example of an operation of the CDIS/CDB 400.

As seen from FIG. 6(a), a first coexistence manager CM1 and a second coexistence manager CM2 are present and are connected to the TVWS database 600 and the CDIS/CDB 400, respectively. The first coexistence manager CM1 and the second coexistence manager CM2 receive location information and frequency information, for example, information about a whitespace map (WM) from the TVWS database 600. The WM may refer to information about a vacant frequency band that is not used by a broadcast service provider in VHF and UHF frequency bands distributed for TV broadcast.

The CDIS/CDB 400 may be connected to the TVWS database 600 and may receive frequency information for broadcast, for example, the WS from the TVWS database 600. In addition, the CDIS/CDB 400 may generate a coexistence whitespace map (CWM) or a coexistence map, as described above, based on the frequency information for broadcast, for example, a WM. In addition, the generated CWM or coexistence may be transmitted to the first coexistence manager CM1 and the second coexistence manager CM2.

As seen from FIG. 6(b), the first coexistence manager CM1 and the second coexistence manager CM2 are connected to the TVWS database 600. The TVWS database 600 may be connected to the CDIS/CDB 400.

The CDIS/CDB 400 may be aforementioned CWM or coexistence map to the TVWS database 600, and the TVWS database 600 may transmit the received CWM or coexistence map to the first coexistence manager CM1 and the second coexistence manager CM2. In this case, the TVWS database 600 may consider and transmit the received CWM or coexistence map as the frequency information for broadcast information, for example, the whitespace map.

Alternatively, the TVWS database 600 may transmit the frequency information for broadcast, for example, the whitespace map as well as the received CWM or coexistence map to the first coexistence manager CM1 and the second coexistence manager CM2. In this case, upon receiving all pieces of frequency information for broadcast, for example, all whitespace maps as well as the received CWM or coexistence map, the first coexistence manager CM1 and the second coexistence manager CM2 may select and use appropriate information among theses.

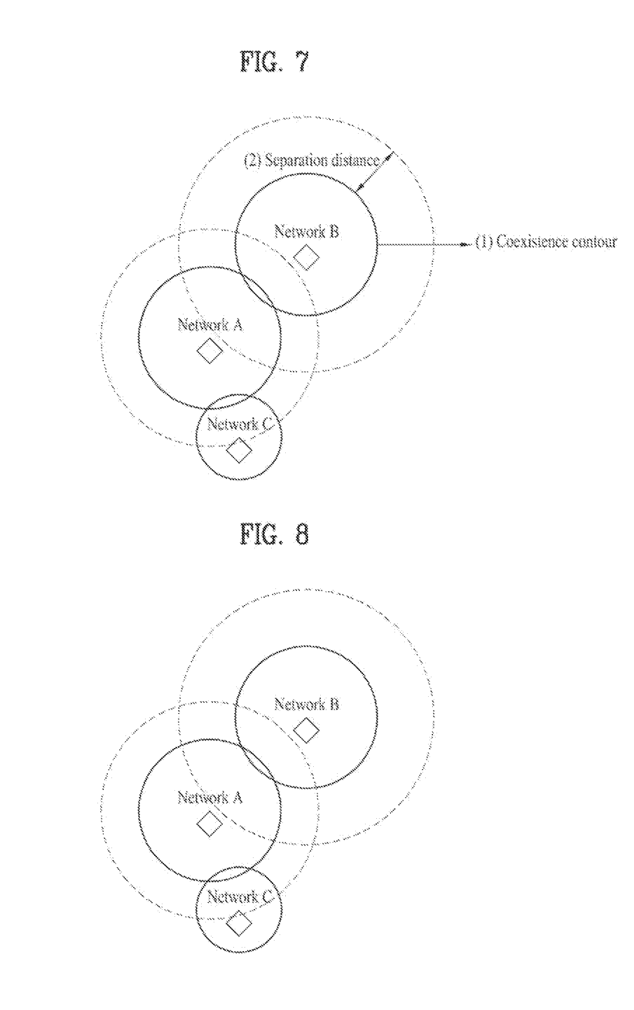

FIG. 7 is a diagram illustrating an example of a coexistence contour.

As seen from FIG. 7, a network A, a network B, and a network C are present adjacent to each other. A coexistence contour of each network is indicated by a solid line and a separation distance of each network is indicated by a dotted line. The coexistence contour is determined according to the characteristics of each network. On the other hand, the separation distance may be determined according to characteristics of relation with another network. As seen from FIG. 6, coexistence contours of the network A and the network B are almost in contact and coexistence contours of the network A and the network C partially overlap each other.

FIG. 8 illustrates an example of a CWM or a coexistence map in the environment of FIG. 7.

As illustrated in an upper right side of FIG. 8, it is assumed that channels #1 to #6 are present. In this case, it is assumed that channels #1 and #2 are being occupied for broadcast according to the frequency information for broadcast, for example, the whitespace map.

As illustrated in FIG. 8, the CDIS/CDB 400 transmits the CWM or coexistence map indicating that channel #4 is an idle channel to the network A. Accordingly, when it is determined that channel #4 is occupied by the network A, the CDIS/CDB 400 transmits the CWM or coexistence map indicating that channels #3, #5, and #6 are idle channels to the network B. Thus, when it is determined that, for example, channel #6 is occupied by the network B, the CDIS/CDB 400 may transmit the CWM or coexistence map indicating that channels #3 and #5 are idle channels to the network C.

Likewise, the CDIS/CDB 400 may transmit the CWM or coexistence map to the networks A, B, and C such that the networks A, B, and C coexist on a wireless communication system.

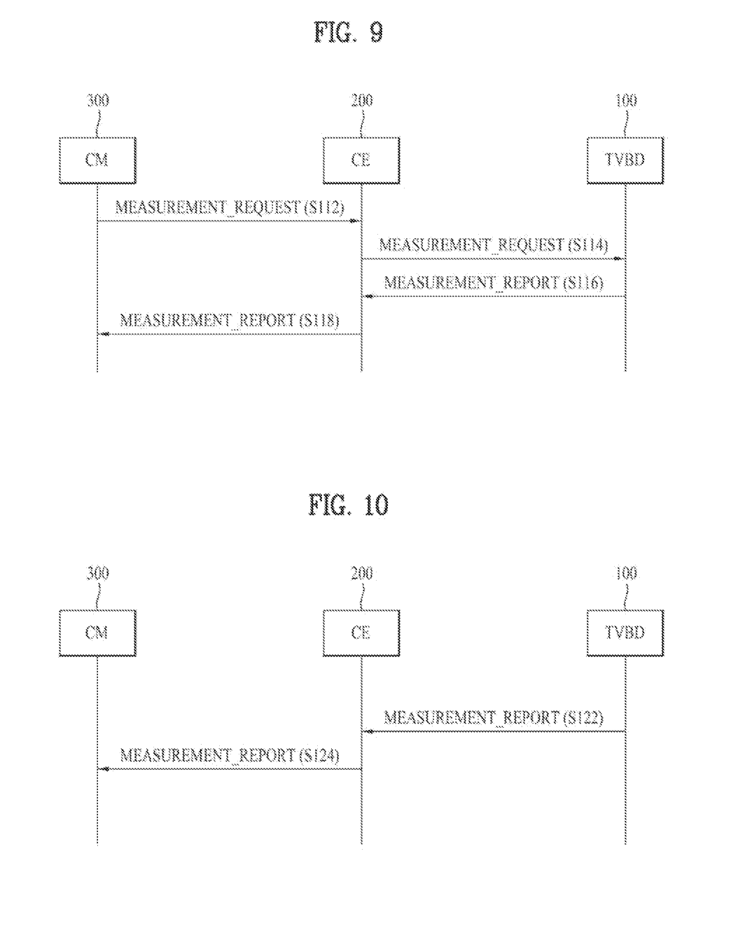

FIG. 9 is a diagram for explanation of a process of receiving occupied channel information and interference level information from the TVBD network or device 100 by the CM 300 according to an embodiment of the present invention.

The TVBD network or device 100 may transmit the occupied channel information and the interference level information to the CM 300 through a measurement message. In this case, the TVBD network or device 100 may transmit a measurement frame format to the CM 300 in response to request of the CM 300.

That is, the CM 300 transmits a measurement_request message to the CE 200 S112, and the CE 200 transmits the received measurement_request message to the TVBD network or device 100 (S114). In addition, the TVBD network or device 100 a measurement report message to the CE 200 in response to the measurement_request message (S116) and the CE 200 transmits the received measurement report message to the CM 300 (S118).

An embodiment of the present invention proposes a method of providing coexistence channel map information for coexistence decision making algorithms. The coexistence channel map includes the list of available channel number, maximum power level, validity, and occupancy for each TVBD network or device that is subscribed to management services. The coexistence channel map may include the list and an ID (CID) of each network or device allocated by a CDIS.

Available channel number: The available channel number field is a positive integer value that indicates that a TV channel is available for an operation of a TVBD network or device. The length of the channel number field is 1 octet.

Max power level: The maximum (transmit) power level field indicates the maximum power, in dBm, allowed for transmission on the channel number.

Validity (Optional): The validity field indicates the time duration in units of minutes for which the channel number is available with the allowed maximum power level.

Occupancy: An occupancy field indicates the percentage in which the channel is used by neighboring TVBD networks or devices. For example, an occupancy field 255 indicates 100%. The occupancy includes interference from both registered and unregistered TVBD networks or devices.

The Occupancy for a channel (Ch1) for a TVBD network or device having CID 1 may be calculated as the follows.

Busy_above_tolerable_interference_level (Ch1)=sum (occupancy report from registered neighboring TVBD networks or devices, and occupancy measured from unregistered neighboring TVBD networks or devices)

Occupancy from a registered neighboring TVBD network or device may be calculated according to Occupancy_Channel_Query_Request/Response. There are two types of registered neighboring TVBD networks or devices: intra-CM neighbors and inter-CM neighbors. The request/response may be transmitted to all inter-CM and intra-CM neighbors of a TVBD network or device that is subscribed to management services. Inter-CM occupancy information may be acquired directly from a neighboring CM via CM to CM information exchange.

The occupancy may be calculated as follows.

Occupancy=Load of a neighbor (if estimated interference level exceeds a threshold)

Occupancy=0 (if estimated interference level is less than a threshold value)

FIG. 10 is a diagram for explanation of a process of receiving occupied channel information and interference level information from the TVBD network or device 100 by the CM 300 according to another embodiment of the present invention.

The TVBD network or device 100 may periodically transmit a measurement frame format to the CM 300. That is, the TVBD network or device 100 periodically transmits measurement report to the CE 200 (S122) and the CE 200 transmits the received measurement report to the TVBD network or device 100 (S122).

A format of a measurement request message may be defined as shown in Table 1 below.

TABLE 1

| Information | | Information | | Measurement | Measurement |
|---|---|---|---|---|---|
| Element | CID | Type | Length | Type | Request |
| Octet | 1 | 1 | 1 | 1 | Variable |

The CID represents an ID of a coexistence device, which is a unique ID allocated by a server (CDIS) which coexistence devices (e.g., TVBD networks or devices) have registered. The CID may be used to identify CEs registered to another CM from a CM or TVBD or TVWS networks or devices. In more detail, when a first CM wants to know information about TVBD or TVWS networks or devices registered to a second CM, the first CM may request the CDIS for IDs of the TVBD or TVWS networks or devices registered to the second CM. In addition, upon receiving the request for the IDs of the TVBD or TVWS networks or devices registered to the second CM from the first CM, the second CM may transmit a response message containing the IDs (i.e., CIDs) of the TVBD or TVWS networks or devices in response to the request.

An information type field may be set to, for example, 3 (measurement request).

The length field represents the length of the measurement request message. The number and lengths of fields in the measurement message field in a single measurement request format are limited by the size of a maximum allowed coexistence protocol data unit (CXPDU), and thus, the length field is limited as shown in Table 1 above.

A measurement type field represents an object of the measurement and may be defined as shown in Table 2 below.

A measurement request field may include a request for a predetermined measurement operation of the TVBD network or device 100 that receives the measurement request. The measurement request field may be repeated for each respective measurement type.

TABLE 2

| Measurement | |
|---|---|
| Type | Description |
| 0 | Reserved |
| 1 | Interference level |
| 2 | Occupied Channel Information |
| 3 | Average Noise Power Indicator (ANPI) |
| 4 | Packet Error Rate (PER) |
| 5 | Channel Load |
| 6 | Neighbor Discovery Information |
| 7 | Threshold Exceed Interference Load |

The measurement type may represent interference level, average noise power indicator (ANPI), packet error rate (PER), and channel load or busy time. In addition, the measurement type may include discovery request, occupied channel information, and threshold exceed interference load. Among these, the threshold exceed interference load may be used to measure accumulated channel busy time for interference that exceeds a threshold specified in a measurement request field over measurement duration.

The measurement request field may be defined according to the measurement type field. In more detail, the measurement request field may be defined for the interference level, the average noise power indicator (ANPI), the PER, and the channel load as shown in Table 3 below.

TABLE 3

| | | | Measurement |
|---|---|---|---|
| Information | Measurement | Measurement | Channel/Frequency |
| Element | Start Time | Duration | numbers |
| Octet | 2 | 1 | Variable |

The measurement start time field may be set to time when requested measurement is started. For example, a value 0 represents that requested measurement is immediately started. The measurement duration field is set to delayed time of requested measurement represented in time units (TUs). Measurement channel/frequency numbers may represent target channel/frequency information to be measured.

When the measurement type field is occupied channel information, TVBD or TVWS networks or devices may report currently occupied channel/frequency information. When the measurement type is occupied channel information, the measurement request field may be defined as shown in Table 4 below.

TABLE 4

| Information | Measurement | Measurement |
|---|---|---|
| Element | Start Time | Duration |
| Octet | 2 | 1 |

When the measurement type field is the discovery request, the measurement request field may be shown in Table 5 below.

TABLE 5

| Information | Neighbor | Occupied |
|---|---|---|
| Element | CM ID | TV channel |
| Octet | 2 | 2 |

When the measurement type field is the threshold exceed interference load, the measurement request field is shown in Table 6 below.

TABLE 6

| | | | | Measurement |
|---|---|---|---|---|
| | | | | Channel/ |
| Information | Measurement | Measurement | Interference | Frequency |
| Element | Start Time | Duration | Threshold | numbers |
| Octet | 2 | 1 | 1 | Variable |

Upon receiving the measurement request as shown in Table 6 above, TVBD or TVWS networks or devices may measure total time when receive power exceeds a threshold specified in the interference threshold while the TVBD or TVWS networks or devices do not transmit and receive any data (i.e., the networks or devices are idle and thus a received signal corresponds to interference). After accumulating all the busy time, the TVBD or TVWS networks or devices may calculate the busy time ratio over the measurement duration. For example, a ratio value 255 means 100% busy ratio.

A format of a measurement report message may be defined as shown in Table 7 below.

TABLE 7

| Information | | Information | Measurement Report |
|---|---|---|---|
| Element | CID | Type | Elements |
| Octet | 1 | 1 | Variable |

The CID represents an ID of a coexistence device, which is a unique ID allocated by a server (CDIS) which coexistence devices (e.g., TVBD networks or devices) have registered.

An information type field of measurement report may be set to, for example, 4.

A measurement report elements field may include one or more measurement report elements. The number and lengths of measurement report elements in a single measurement report frame may be limited by a size of a maximum allowed CXPDU.

The measurement report elements may be defined as shown in Table 8 below.

TABLE 8

| Information | | Measurement | Measurement |
|---|---|---|---|
| Element | Length | Type | Report |
| Octet | 1 | 1 | Variable |

The length field represents the length of the measurement request message. The number and lengths of fields in the measurement message field in a single measurement request format are limited by the size of a maximum allowed coexistence protocol data unit (CXPDU), and thus, the length field is limited.

The measurement type field may be defined as shown in Table 2 above. The measurement type may represent the interference level, the ANPI, the PER, the channel load (or busy time), the occupied channel information, and the neighbor discovery or threshold exceed interference load.

The measurement report field for the interference level, the ANPI, the PER, and the channel load may be defined as shown in Table 9 below.

TABLE 9

| | Actual | | Measured | |
|---|---|---|---|---|
| Information | Measurement | Measurement | Channel/ | Interference |
| Element | Start Time | Duration | Frequency | Level Report |
| Octet | 8 | 1 | 6 | Variable |

The actual measurement start time field is set to time when measurement is started. The measurement duration field may be set to delayed time represented in time units (TUs) for the measurement duration. The interference level report field may be periodically repeated. The interference level report field may represent a detected TVBD network or device.

When the measurement type field represents occupied channel information, a measurement report field corresponding to the occupied channel information may be shown in Table 10 below.

TABLE 10

| | | | | Occupied |
|---|---|---|---|---|
| | Actual | | | Channel |
| Information | Measurement | Measurement | | Information |
| Element | Start Time | Duration | CID | Report |
| Octet | 8 | 2 | 1 | Variable |

The actual measurement start time field is set to time when measurement is started. The measurement duration field may be set to delayed time represented in time units (TUs) for the measurement duration. The CID represents an ID of a coexistence device, which is a unique ID allocated by a server (CDIS) which coexistence devices (e.g., TVBD networks or devices) have registered. In addition, the occupied channel information report field may be defined as shown in Table 11 below.

TABLE 11

| Device Type | Description |
|---|---|
| 0 | Reserved |
| 1 | Channel Number |
| 2 | Power |
| 3-7 | Reserved |

When the measurement type field represents neighbor discovery, a measurement report field corresponding to the neighbor discovery may be shown in Table 12 below.

TABLE 12

| Information | Channel/ | Channel |
|---|---|---|
| Element | Frequency | Load |
| Octet | 2 | 2 |

The channel/frequency field may include a channel or frequency ID on which the measurement is performed. The channel load represents use of channel/frequency by neighboring TVBD or TVWS networks or devices.

The measurement report field for the threshold exceed interference load is shown in Table 13 below.

TABLE 13

| Information | Channel/ | Channel |
|---|---|---|
| Element | Frequency | Load |
| Octet | 2 | 2 |

The channel/frequency field may include a channel or frequency ID on which the measurement is performed. The channel load represents the channel/frequency busy time by an interference level that exceeds the threshold by neighboring TVBD or TVWS networks or devices.

FIG. 11 is a diagram for explanation of a process of discovering a neighbor set of the TVBD network or device 100 by the CM 300 according to an embodiment of the present invention.

First, the CDIS 400 receives neighbor information, timing information, resource information, interference level information, etc. from the TVBD network or device 100 or the CM 300 to calculate a neighbor set and transmits the calculated neighbor set to the CM 300 (S210).

The CM 300 transmits a request for occupied channel information of a neighbor TVBD network or device 100 including the neighbor set to the CM 300 (S220). The CM 300 receives the occupied channel information of the neighbor TVBD network or device 100 from a neighbor CM 300 (S230).

The CM 300 compares an available channel of the TVBD network or device 100 and an occupied channel of the neighbor TVBD network or device 100. In addition, the CM 300 checks a channel included in the available channels of the neighbor TVBD network or device 100 among channels included in the available channels of the TVBD network or device 100 (calculation of repeated channels). In addition, the CM 300 generates a channel table (or a priority table) for varying a channel included in the occupied channels of the neighbor TVBD network or device 100 and a channel that is not included in the occupied channels of the neighbor TVBD network or device 100 among channels included in the available channels of the TVBD network or device 100 (S240).

Here, among channels included in the available channels of the TVBD network or device 100, the channels included in the available channels of the neighbor TVBD network or device 100 may have lower priority than the channel that is not included in the occupied channel of the neighbor TVBD network or device 100. In addition, the channel table (or the priority table) may be classified into a table according to occupied channel information and a table according to the number of TVBD networks or devices 100 served by each CM 300. A table may be stabled by combining the types of tables.

The CM 300 transmits the generated channel table (priority table) to the TVBD network or device 100 (S250).

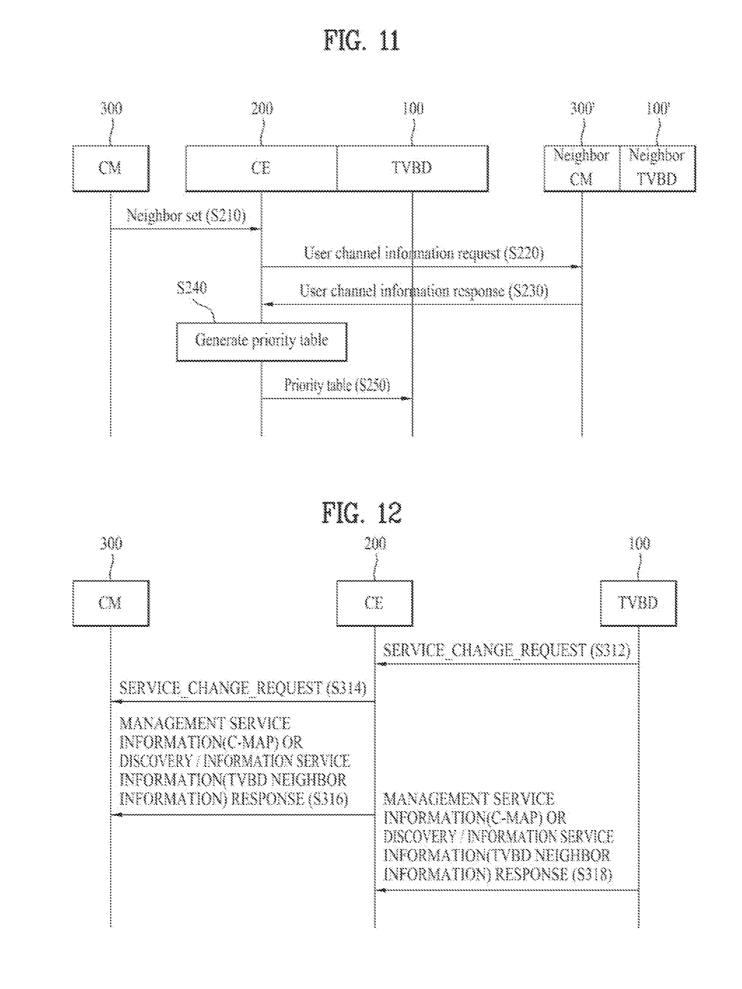

FIG. 12 is a diagram illustrating a service changing process of the TVBD network or device 100 or the CM 300 according to an embodiment of the present invention.

A coexistence system may provide two types of services. A first service (a management service) may be a service in which the CM 300 determines an available channel of the TVBD network or device 100 based on various pieces of information such as neighbor information, timing information, resource information, interference level information, etc., transmits the determined available channel information to the TVBD network or device 100, and manages the available channel information.

A second service (discovery/information service) may be a service in which the TVBD network or device 100 receives a neighbor set from the CDIS 400, receives an available channel list from the TVWS database 600, and determines an available channel. Change between the first service and the second service may be performed by the TVBD network or device 100 or the CM 300. In addition, the TVBD network or device 100 may receive service information from the CM 300 and select any one of the first service and the second service as a service of the coexistence system based on the received service information.

The TVBD network or device 100 may determine whether a service is changed based on the available channel information received from the CM 300. The TVBD network or device 100 may determine to change the first service to the second service when there is no required available channel (for example, when a channel with a sufficient size cannot be ensured even if a plurality of adjacent channels is aggregated). In this case, the TVBD network or device 100 transmits a service change request to the CE 200 (S312) and the CE 200 transmits the service change request to the CM 300 (S314). The CM 300 transmits first service information (C-MAP) or second service information (TVBD neighbor information) to the CE 200 in response to the service change request (S316), and the CE 200 transmits the received service information to the TVBD network or device 100 (S318).

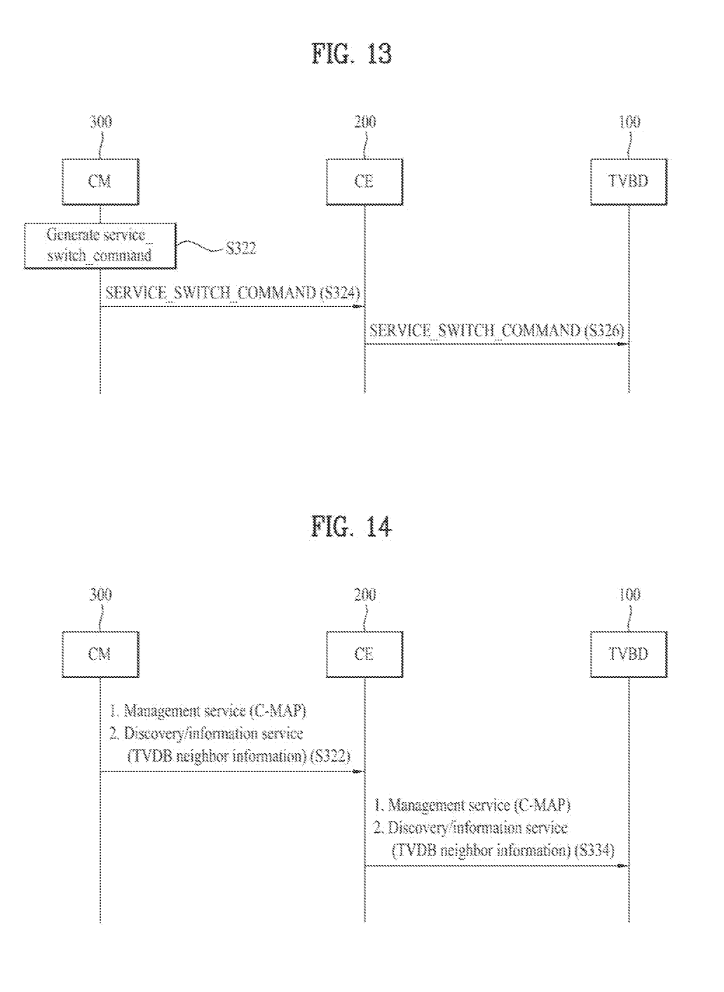

FIG. 13 is a diagram illustrating a service changing process of the TVBD network or device 100 or the CM 300 according to another embodiment of the present invention.

The CM 300 generates service_switch_command based on various pieces of information such as neighbor information, timing information, resource information, interference level information, etc. received from the CDIS/CDB 400 and the TVBD network or device 100 (S322) and transmits the generated service_switch_command to the CE 200 (S324), and the CE 200 transmits the received service_switch_command to the TVBD network or device 100 (S326).

A service changing request frame format may be defined as shown in Table 14 below.

TABLE 14

| | | | | Service |
|---|---|---|---|---|
| | | | | Changing |
| Information | | Information | Dialog | Request |
| Element | CID | Type | Token | Element |
| Octet | 1 | 1 | | Variable |

An information type field is set to 9 (service changing request frame) indicating a service changing request frame. A service changing request element format is defined as shown in Table 15 below.

TABLE 15

| Information | | Command | Command |
|---|---|---|---|
| Element | Length | Type | Request |
| Octet | 1 | 1 | Variable |

A command type field is defined as shown in Table 16 below.

TABLE 16

| Command Type | Description |
|---|---|
| 0 | Reserved |
| 1 | Service Changing |
| 2-7 | Reserved |

A command type in a service changing command request element may indicate service changing. A service changing request field corresponding the service changing command request element may be defined as shown in Table 17 below.

TABLE 17

| Information | TVBD | Service |
|---|---|---|
| Element | Address/CM ID | Type |
| Octet | 6 | Variable |

A length is a variable subject to a length value of a service type field.

A service changing response frame format may be defined as shown in Table 18 below.

TABLE 18

| | | | | Service |
|---|---|---|---|---|
| | | | | Changing |
| Information | | Information | Dialog | Response |
| Element | CID | Type | Token | element |
| Octet | 1 | 1 | 1 | Variable |

An information type field is set to 10 (service changing response frame) indicating a service changing response frame. A service changing response element format is defined as shown in Table 19 below.

TABLE 19

| Information | | Command | Command |
|---|---|---|---|
| Element | Length | Type | response |
| Octet | 1 | 1 | Variable |

A command type field is defined as shown in Table 16 above.

A command type of the service changing command response element may indicate service changing. A service changing response field corresponding to the service changing command response element may be defined as shown in Table 20 below.

TABLE 20

| Information Element | Status |
|---|---|
| Octet | 1 |

A status code field indicates success or failure of a requested operation. A length of a status code may be 1. Allocated status codes may be defined as shown in Table 21 below.

TABLE 21

| Measurement Type | Description |
|---|---|
| 0 | Reserved |
| 1 | Reserved |
| 2 | Success |
| 3 | Unspecified failure |
| 4-255 | Reserved |

FIG. 14 is a diagram illustrating a service selection process of the TVBD network or device 100 according to another embodiment of the present invention.

The CM 300 transmits coexistence map (C-map) for a first service and neighbor information for a second service to the CE 200 (S332), and the CE 200 transmits the received neighbor information to the TVBD network or device 100 (S334). The TVBD network or device 100 selects a service based on the received neighbor information.

A service switching frame format is defined as shown in Table 22 below.

TABLE 22

| Information | | Information | Service Switching |
|---|---|---|---|
| Element | CID | type | Request Elements |
| Octet | 1 | 1 | Variable |

An information type field may be set to 11 (service switching request). A service switching request elements field may include one or more service switching request elements. The number and length of service switching request elements in a single measurement request frame may be limited by the size of a maximum allowed CXPDU. A service switching request element may include a request for a service switching operation of the TVBD network or device 100 that receives the service switching request.

A service switching request element format may be defined as shown in Table 23 below.

TABLE 23

| Information | | Service | Service Switching |
|---|---|---|---|
| Element | Length | type | request |
| Octet | 1 | 1 | Variable |

A measurement type field may be defined as shown in Table 24 below.

TABLE 24

| Measurement Type | Description |
|---|---|
| 0 | Reserved |
| 1 | Service Switching |
| 2-7 | Reserved |

A service type field may be defined as shown in Table 25 below.

TABLE 25

| Information | Management Service | Discovery/Information |
|---|---|---|
| Element | information | Service information |
| Octet | 2 | 2 |

A management service sub-element field may be defined as shown in Table 26 below.

TABLE 26

| | | | | Available |
|---|---|---|---|---|
| Information | Sub-element | | Received | Channel |
| Element | ID | Length | Power | Numbers |
| Octet | 1 | 1 | 1 | Variable |

A discovery/information service sub-element field may be defined as shown in Table 27 below.

TABLE 27

| Information | Sub-element | | | Neighbor TVBD |
|---|---|---|---|---|
| Element | ID | Length | CM ID | information |
| Octet | 1 | 1 | 1 | |

A service switching request element field may be defined as shown in Table 28 below.

TABLE 28

| Information | Service | Service |
|---|---|---|
| Element | Type | Changing Command |
| Octet | 2 | 2 |

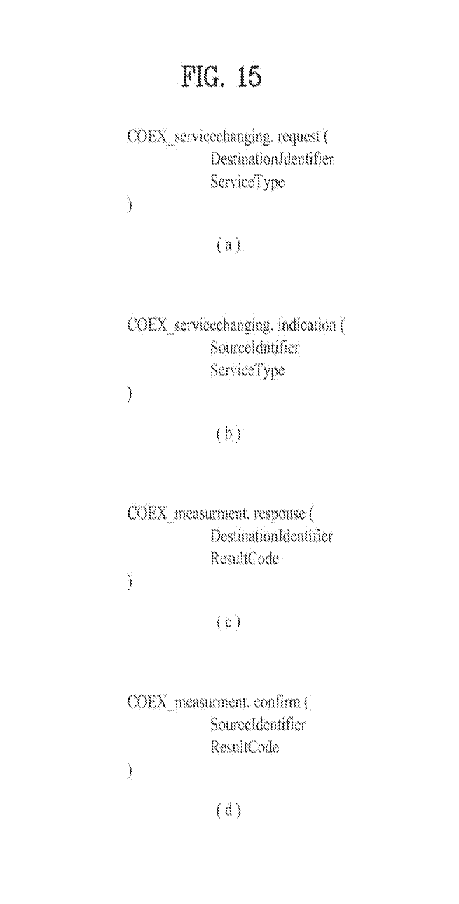

FIG. 15(a) is a diagram illustrating semantics of a service primitive of coexistence service changing request according to an embodiment of the present invention.

COEX_Servicechanging.request is used by a COEX user in order to change a service type. A parameter of COEX_Servicechanging.request is defined as shown in Table 29 below.

TABLE 29

| Name | Data type | Description |
|---|---|---|
| DestinationIdentifier | CID | which identifies a local |
| | | COEX entity or remote |
| | | COEX entity to be a |
| | | destination of this request. |
| ServiceType | SERVICETYPE_ID | Service type |

COEX_Servicechanging.request is generated by the COEX user in order to change a service type. When a destination of the request is a local COEX entity, the local COEX entity responds with COEX_Servicechanging.confirm. When the destination of the request is a remote COEX entity, the local COEX entity may generate a Servicechanging Request message corresponding to the remote COEX entity.

FIG. 15(b) is a diagram illustrating semantics of a service primitive of coexistence service changing indication according to an embodiment of the present invention.

COEX_Servicechanging.indication is used by a COEX entity in order to indicate reception of a Servicechanging Request message from a peer COEX entity to a COEX user. A parameter of COEX_Servicechanging.indication is defined as shown in Table 30 below.

TABLE 30

| Name | Data type | Description |
|---|---|---|
| SourceIdentifier | CID | which identifies a caller of a |
| | | primitive to be a local COEX |
| | | entity or a remote COEX |
| | | entity. |
| ServiceType | SERVICETYPE_ID | Service type |

When the COEX_Servicechanging.request message is received, the parameter of COEX_Servicechanging.indication is used by a COEX entity for indication to the COEX user. Upon receiving the indication, the COEX user responds with COEX_servicechanging.reponse primitive.

FIG. 15(c) is a diagram illustrating semantics of a service primitive of a coexistence service changing response according to an embodiment of the present invention.

In order to transmit servicechanging information to a COEX user that calls Servicechanging request, COEX_Servicechanging.response is used by the COEX user. A parameter of COEX_Servicechanging.response is defined as shown in Table 31 below.

TABLE 31

| Name | Data type | Description |
|---|---|---|
| DestinationIdentifier | CID | which identifies a remote |
| | | COEX entity to be a |
| | | destination of this response. |
| ResultCode | Enumeration | A request result is reported. |

The parameter of COEX_Servicechanging.response is used by the COEX user in response to the received COEX_Servicechanging.indication. Upon receiving a response, the COEX entity may generate a corresponding COEX_servicechanging.report message and transmit the message to a destination COEX entity.

FIG. 15(d) is a diagram illustrating semantics of a service primitive of coexistence service changing confirmation according to an embodiment of the present invention.

COEX_Servicechanging.confirm is used by the COEX entity in order to transmit servicechanging information to a COEX user that calls servicechanging request. A parameter of COEX_Servicechanging.confirm is defined as shown in Table 32 below.

TABLE 32

| Name | Data type | Description |
|---|---|---|
| SourceIdentifier | CID | which identifies a caller of |
| | | this primitive to be a local |
| | | COEX entity or a remote |
| | | COEX entity. |
| ResultCode | Enumeration | A request result is reported. |

The parameter of COEX_Servicechanging.confirm is called by the local COEX entity in order to transmit a result of a primitive of COEX_Servicechanging.request from a previous COEX user. Upon receiving the primitive, the COEX user performs appropriate determination and appropriate operations. However, ResultsCode does not indicate “Success”, a receiver performs appropriate error handling.

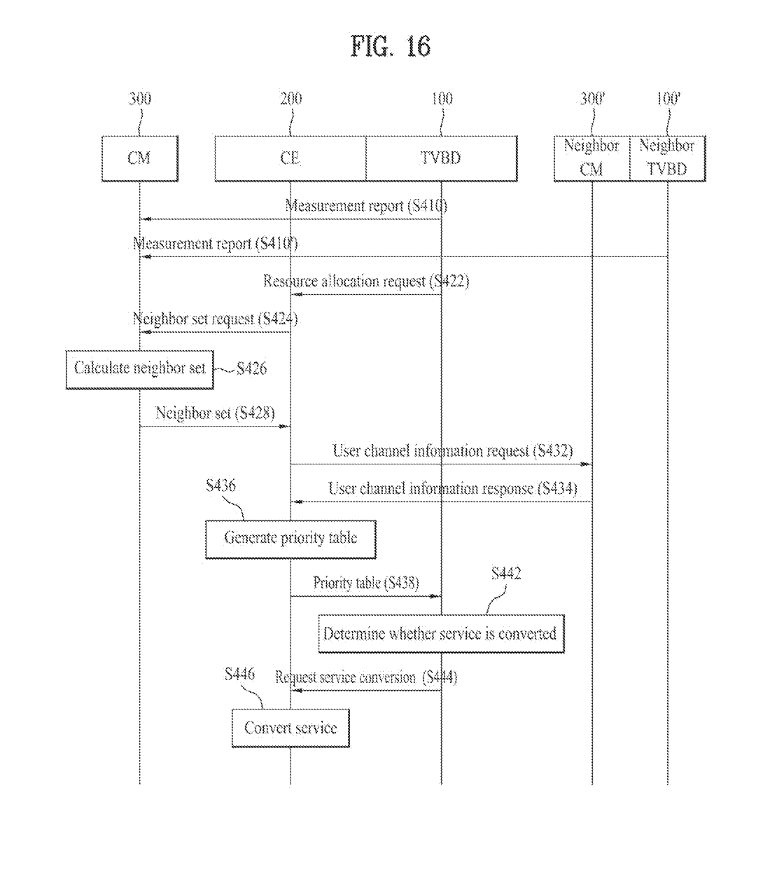

FIG. 16 is a diagram illustrating a service changing process of the CM 300 according to an embodiment of the present invention.

First, the TVBD network or device 100 and a neighbor TVBD network or device 100 are registered to the CM 300 and the CDIS/CDB 400. In addition, the CM 300 and a neighbor CM 300 are registered to the CDIS/CDB 400.

As described above, the TVBD network or device 100 registered to the CM 300 and the CDIS/CDB 400 transmits a measurement report to the CM 300 periodically or according to a request of the CM 300 (S410). In addition, as described above, the CM 300 and the neighbor TVBD network or device 100 transmit a measurement report to a neighbor CM periodically or according to a request of the neighbor CM 300 (S410).

The measurement report may include occupied channel information and interference level information of the TVBD network or device 100. The measurement report includes the interference level information of the TVBD network or device 100 in order to more accurately calculate a neighbor set than a case in which the neighbor set is calculated using only available channel information of TVBD network or device 100 by an existing CDIS/CDB 400.

In addition, upon receiving request for resource allocation, the TVBD network or device 100 may request the CM 300 for resource allocation (S422). In this case, the TVBD network or device 100 may receive available channel information from the TVWS DB 600 and transmit the available channel information to the CM 300. Upon receiving request for resource allocation from the TVBD network or device 100, the CM 300 requests the CDIS/CDB 400 for a neighbor set (S424).

Here, the neighbor set may include information about the neighbor TVBD network or device 100 of the TVBD network or device 100 and the neighbor CM 300 that serves the neighbor TVBD network or device 100. The CDIS/CDB 400 may calculate the neighbor set based on geo-location information of TVBD network or devices 100 registered to the CDIS 400 (S426). The CM 300 may receive the neighbor set calculated by the CDIS/CDB 400 (S428).

The CM 300 may request the neighbor CM 300 for available channel information based on the neighbor set (S432). In this case, the CM 300 may transmit information about the neighbor TVBD network or device 100 of the TVBD network or device 100 to the neighbor CM 300.

The neighbor CM 300 may transmit occupied channel information of the neighbor TVBD network or device 100 to the CM 300 based on the measurement report received from the neighbor TVBD network or device 100 (S434).

The CM 300 may generate a priority table based on the available channel information of the TVBD network or device 100 and the occupied channel information of the neighbor TVBD network or device 100 received from the neighbor CM 300 (S436). The available channel information of the TVBD network or device 100 may be received from the TVWS database 600 by the TVBD network or device 100 and transmitted to the CM 300, may be received from the TVWS database 600 by the CM 300, or may be received from the TVWS database 600 by the CDIS/CDB 400 and transmitted to the CM 300.

In addition, the CM 300 may transmit the generated priority table to the TVBD network or device 100 (S438). The occupied channel information of the neighbor TVBD network or device 100 is received from the neighbor CM 300 by the CM 300 in order to determine an actual available channel of the TVBD network or device 100.

The TVBD network or device 100 determines whether a service is changed based on the priority table received from the CM 300 (S442). That is, the TVBD network or device 100 checks whether there is a desired channel among channels included in the available channels of the TVBD network or device 100 and determines to change the service when the desired channel is not present.

In this case, the TVBD network or device 100 requests the CM 300 for service change (S444). The CM 300 changes the service in response to the request from the TVBD network or device 100 (S446). In this case, the CM 300 may transmit the neighbor set to the TVBD network or device 100. The TVBD network or device 100 may negotiate an available channel with the neighbor CM 300 based on the neighbor set received from the CM 300 in order to ensure a desired channel received from the CM 300.

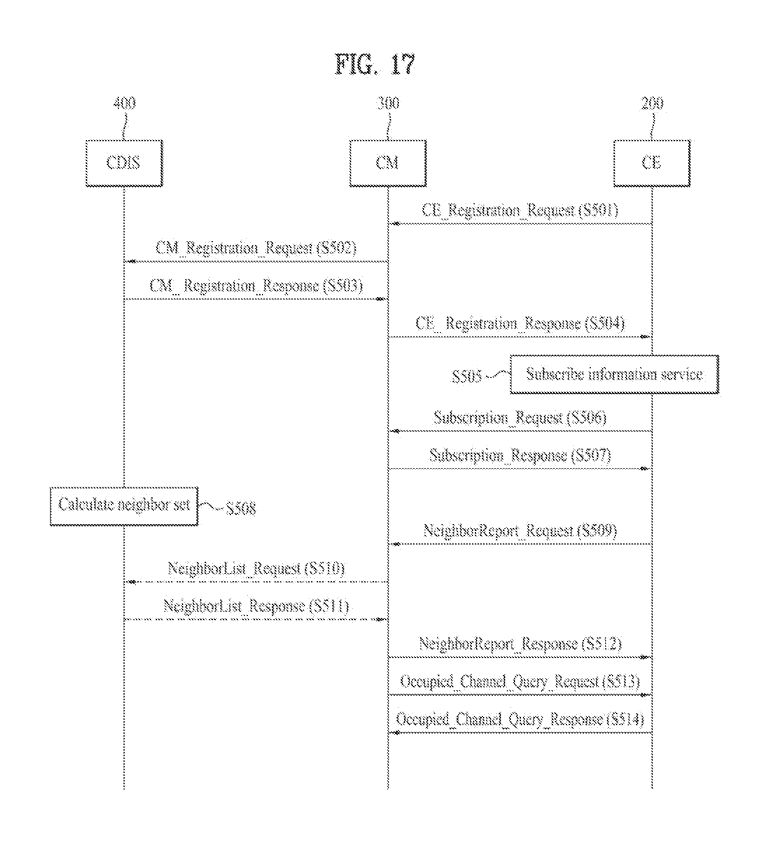

FIG. 17 is a message flowchart for estimation of interference according to an embodiment of the present invention. FIG. 17 illustrates a WSO registration procedure, a WSO service subscription procedure, a neighbor report procedure, and an occupied channel query procedure. These four procedures may not be always sequentially performed and may be separately performed. The CE 200 may acquire WSO registration information. After acquisition of the WSO registration information, the CE 200 may generate a request message for CE registration, for example, a CE_Registration_Request message and transmit the CE_Registration_Request message to the CM 300 that serves the CE 200.

In more detail, the CE 200 may transmit a registration information request message for requesting a WSO (not shown) for registration information, for example, a GetRegInfo request message. In response to the GetRegInfo.request message, the WSO may transmit a registration information response message, for example, a GetReginfo.response message to the CE 200, and the registration information response message may include the requested registration information. Upon receiving the registration information response message, the CE 200 may transmit a request message for CE registration, for example, a CE_Registration_Request message to the CM 300 (S501). The CE 200 may wait for a CE registration response message, for example, the CE_Registration_Response message from the CM 300, and re-transmit the request message to the CM 300 when the CE 200 does not receive the response message within predetermined time.

Then, the CM 300 may perform WSO registration, and transmit a CM registration request message, for example, a CM_Registration_Request message to the CDIS 400 in order to register or update registration information of the WSO (S502). The CM registration request message may include information about the maximum number of WSOs controllable by the CM, geo-location of the CM, and a radius of coverage of the CM and may include a great amount of information. In addition, the CM 300 may wait for a CM registration response message corresponding to the CM registration request message from the CDIS 400, and re-transmit the CM registration request message to the CDIS 400 when the CM 300 does not receive the response message within predetermined time.

Upon receiving the CM registration request message, the CDIS 400 may perform the CM registration and transmit a CM registration response message, for example, a CM_Registration_Response message to the CM 300 (S503).

The CM 300 may transmit a registration response message for reception confirmation response to a request message for CE registration from the CE 200, for example, a CE_Registration_Response message to the CE 200 (S504).

In some embodiments, an order of S502 to S504 of an order of operations described with reference to FIG. 17 may be changed. In particular, although FIG. 17 illustrates a case in which transmission (S504) of the CE registration response message to the CE 200 from the CM 300 is performed after transmission of the CM registration response message (S503) to the CM 300 from the CDIS 400, transmission of the CE registration response message to the CE 200 from the CM 300 may perform any time before transmission (S501) of the CE registration request message to the CM 300 from the CE 200.

Upon receiving the CE registration response message, the CE 200 may perform a WSO subscription procedure. The CE 200 may subscribe the WSO to one of the information service and the management service. According to the present embodiment, the CE 200 may subscribe to the information service (S505). Needless to say, S505 corresponds to determination for subscription and an actual subscription procedure is performed after operations S506 and S507.

After acquisition of subscription information from the WSO, the CE 200 may transmit a Subscription_Request message for service subscription request to the CM 300 to the CM 300 (S506). Upon receiving the Subscription_Request message, the CM 300 may perform WSO subscription. When the CE 200 does not subscribe to any service, the CM 300 may process the Subscription_Request message, generate a Subscription_Response message as a response to the Subscription_Request message, and transmit the Subscription_Response message to the CE 200. However, when the CE 200 has already subscribed to a service and transmits the Subscription_Request message in order to subscribe to another new service, the CM 300 may indicate the Subscription_Request message to all other CMs. Upon receiving the Subscription_Response message, the CE 200 may process the message. When the CE 200 can transmit a message associated with service subscription confirmation to the WSO and a state indicator contained in the Subscription_Response message is ‘TRUE’ (that is, subscription is successful), the CE 200 may convert a service for the WSO into a corresponding service.

Then, the CE 200 may a NeighborReport_Request message as a preceding procedure for determining channel/frequency to be occupied by the CE 200 to the CM 300 (S509). Thus, the CM 300 may transmit a NeighborReport_Response message containing information about neighbor TVBD or TVWS networks or devices (that is, neighbor WSOs) adjacent to the CE to the CE 200 (S512). The information may contain information about channel/frequency occupied by the neighbor TVBD or TVWS networks or devices, and information about positions, etc. of the TVBD or TVWS networks or devices.

The CE 200 may select channel/frequency to be occupied. In addition, the CM 300 needs to know information about channel/frequency occupied by the CE 200 subscribes information service. Thus, the CM 300 may transmit an Occupied_Channel_Query_Request message for a query about a channel occupied by the CE 200 to the CE 200 (S513). A format of the Occupied_Channel_Query_Request message is shown in Table 33 below.

TABLE 33

| Information | | Information | Measurement |
|---|---|---|---|
| Element | CID | Type | Duration |
| Octet | 1 | 1 | 2 |

The Occupied_Channel_Query_Request message may be transmitted to a CE from a CM in order to request a list of channel occupied by the CE based on a channel selection algorithm used by TVBD or TVWS networks or devices. This is for updating a list of interfering frequencies or channels in order to manage a coexistence decision making algorithm.

In other words, a TVWS apparatus (or a CE) (hereinafter, referred to as an “information service apparatus”) that subscribes the information service selects a channel or frequency to be occupied by the information service apparatus based on the algorithm, and thus, the CM cannot know a channel or frequency occupied by the information service apparatus. The CM allocates a channel or frequency to be occupied by a TVWS apparatus (or a CE) (hereinafter, referred to as a “management service apparatus”) that subscribes a management service.

However, as described above, since the CM cannot know information about a channel or frequency occupied by the information service apparatus, a channel or frequency that has been already used by the information service apparatus can be redundantly allocated to the management service apparatus. In this case, interference occurs in the management service apparatus due to the redundant allocation, which means that it becomes difficult to provide an appropriate service.

That is, an occupied channel of the information service apparatus may act as interference to the management service apparatus. To overcome this, it is required to collect information about the channel occupied by the information service apparatus.

The CID refers to an ID of a coexistence device, which corresponds to a unique ID allocated by a server (CDIS) to which coexistence devices (e.g., TVBD or TVWS networks or devices) are registered. In addition, the CID can identify CEs or TVBD or TVWS networks or devices that are registered to another CM from a CM. In more detail, when a first CM wants to know information about TVBD or TVWS networks or devices registered to a second CM, the first CM may request the CDIS for IDs of the TVBD or TVWS (i.e. registered WOSs) registered to the second CM. In addition, when receiving a request for IDs of TVBD or TVWS networks or devices from the first CM, the second CM may transmit a response message containing IDs (i.e., CIDs) of the TVBD or TVWS networks or devices in response to the request.

The information type may include a request type of the message. The measurement duration is a field indicating delay of measurement for acquisition of a busy ratio.

Then, the CM 300 may generate an Occupied_Channel_Query_Response message and transmit the message to the CE 200 (S514). The Occupied_Channel_Query_Response message may include information associated with a channel occupied by the CE 200 or a WSO on which the CE is installed. The Occupied_Channel_Query_Response message is a message transmitted to a CM from a CE in order to report a list of operating channels or frequencies. The Occupied_Channel_Query_Response message may include information of an occupied channel or frequency and maximum allowed power in each frequency or channel. The maximum power information may be used to estimate an interference level for a WSO. In addition, the Occupied_Channel_Query_Response message may indicate a list of load information about each occupied channel, and the information may be used to estimate an occupancy ratio by a neighbor WSO.

A format or configuration of the Occupied_Channel_Query_Response message is shown in Table 34 below.

TABLE 34

| | | | numOf- | |
|---|---|---|---|---|
| Information | | Information | Occupied- | ListOfOperating |
| Element | CID | Type | Channel | Channels |
| Octet | 1 | 1 | 1 | Variable |
| Information | ListOfMax- | ListOfLoad | | |
| Element | Powerin- | | | |
| | Operating- | | | |
| | Channel | | | |
| Octet | Variable | Variable | | |

The CID field is an ID of a registered WSO, and the information type field is a type of the Occupied_Channel_Query_Response message. A numOfOccupiedChannel field indicates the number of occupied channels and a ListOfOperatingChannels field indicates a list of occupied channels. A ListOfMaxPowerinOperatingChannel field may indicate a list of maximum power of occupied channels, and a LisgOfLoad field may indicate channel busy time for each occupied channel measured by the WSO.

Although not illustrated, when information about the occupied channel or frequency is changed, the CE 200 may transmit an Occupied_Channel_Query_Update message for indicating the change to the CM 300. Upon receiving the Occupied_Channel_Query_Update message, the CM 300 may update information the aforementioned occupied channel or frequency.

S508, S510, and S511 of FIG. 17 correspond to S424 to S428 of FIG. 16 and thus are not described herein.

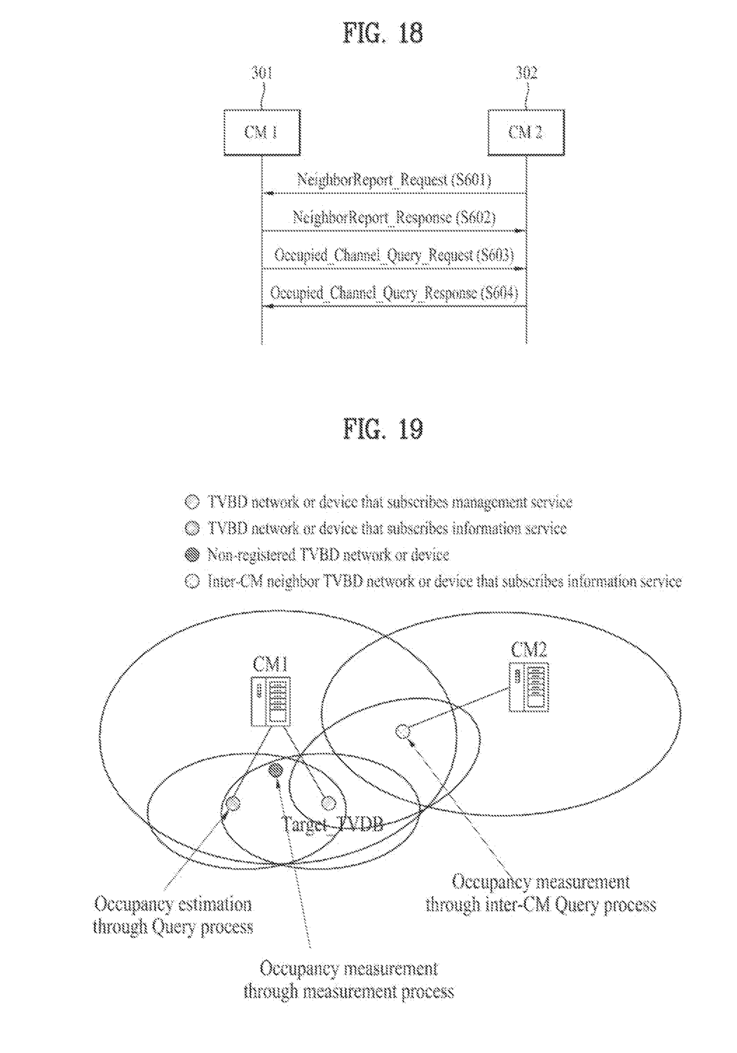

FIG. 18 is a message flowchart for interference estimation according to an embodiment of the present invention. In the embodiment of FIG. 18, message exchange between a CM and a CE in the embodiment described with reference to FIG. 17 can also be performed between CMs. Thus, the message flowchart of FIG. 18 is partially the same as FIG. 17. That is, S509, S512, S513, and S514 of FIG. 17 correspond to operation S601 to S604 of FIG. 18, respectively, but their transmission or reception subjects are different from in FIG. 17. Thus, a detailed description of FIG. 18 will be omitted.

FIG. 19 illustrates a type of interference to a TVWS and an estimating method for the interference. FIG. 19 illustrates examples of different interference sources. FIG. 19 illustrates 1) inference from intra-CM neighbor TVBD networks or devices that subscribe an information service, 2) interference from neighbor TVBD or TVWS networks or devices that are not registered, and 3) interference from different inter-CM neighbor TVBD networks or devices that subscribe an information service. Different interference estimation mechanisms may be provided to the respective interferences.

With regard to 1), the interference may be calculated using the Occupied_Channel_Query_Request message and Occupied_Channel_Query_Response message that have been described with reference to FIG. 17. A described description can be understood with reference to FIG. 17.

With regard to 2), the interference may be estimated/calculated via a measurement procedure associated with FIG. 9 or 10. A CM needs to acquire information about unknown interference caused by neighbor TVBD or TVWS networks or devices that are not registered to any CM. This can be performed by transmitting a measurement request to each TVBD or TVWS network or device in order to measure interference to TVBD or TVWS networks or devices.

With regard to 3), the inference information may be calculated/estimated via information exchange between CMs.

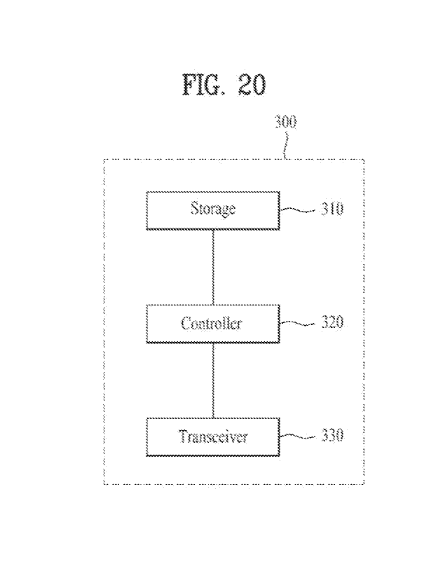

FIG. 20 is a block diagram of the CM 300 according to an embodiment of the present invention. As illustrated in FIG. 20, the CM 300 includes a storage 310, a controller 320, and a transceiver 330.

The storage 310 may store a signal process for a method according to the embodiment described with reference to FIGS. 1 to 19. The controller 320 may control the storage 310 and the transceiver 330. In detail, the controller 320 executes the methods stored in the storage 310. The controller 320 transmits the aforementioned signals via the transceiver 330.

The method according to the present invention that has been described thus far may be embodied in the form of software, hardware, or a combination thereof. For example, the method according to the present invention may be stored in a storage medium (e.g., a mobile terminal internal memory, a flash memory, a hard disk, etc.) and may be embodied in the form of codes or commands in a software program that can be executed by a processor (e.g., a mobile terminal internal micro processor).

A UE or apparatus according to embodiments of the present invention as an example of hardware may be interpreted as including a mobile terminal (e.g., a UE, a mobile equipment (ME), a user terminal (UT), a subscriber station (SS), a mobile subscriber station (MSS), a wireless device, a handheld device, and an access terminal (AT)), a digital television (TV), a global positioning system (GPS) navigation player, a portable gaming player, an MP3 player, other home appliances, etc. by which the aforementioned embodiments are embodied.

Thus far, an apparatus and method according to at least one of the disclosed embodiments of the present invention has been described with reference to the exemplified drawings. However, it will be apparent to those skilled in the art that the present invention is not limited by the disclosed embodiments of the present invention and the drawings and various modifications may be formed by those skilled in the art within the scope of the technical spirit of the present invention.

Configurations and methods according to the aforementioned embodiments are not limited to the aforementioned method for selecting a master device in a coexistence system. The aforementioned embodiments may be entirely or partially combined and configured to form various modifications.

Terms or words used herein shall not be limited to having common or dictionary meanings, and have the meanings corresponding to technical aspects of the embodiments of the present invention so as to most suitably express the embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

Embodiments of the present invention are applicable to an apparatus, a server, etc. in a television white space (TVWS) band.

1. A method for acquiring information about an occupied channel of an apparatus (hereinafter, an information service apparatus) subscribing an information service for channel allocation for an apparatus (hereinafter, a management service apparatus) subscribing a management service in a television white space (TVWS) network in which the information service apparatus and the management service apparatus coexist, the method being performed by a management apparatus, the method comprising:
transmitting an occupied channel query request message for query of information about one or more channels (hereinafter, occupied channels) occupied by the information service apparatus, to the information service apparatus; and
receiving an occupied channel query response message including the information about the occupied channels, from the information service apparatus,
wherein the occupied channel query request message includes an identification (ID) of the information service apparatus and information about a measurement period of the occupied channels; and
the information service apparatus and the management service apparatus are TVWS apparatuses.

2. The method according to claim 1, wherein the occupied channel query response message includes an ID of the information service apparatus, the number of the occupied channels, a list of the occupied channels, a maximum power list of each of the occupied channels, and a channel busy time of each of the occupied channels.

3. The method according to claim 1, further comprising:
receiving a neighbor report request message for requesting information about at least one neighbor management service apparatus, from the information service apparatus; and
transmitting a neighbor report response message including information about the at least one neighbor management service apparatus, acquired via measurement report from the at least one neighbor management service apparatus, to the information service apparatus,
wherein:
the information about the at least one neighbor management service apparatus includes at least one of information about a channel or frequency occupied by the at least one neighbor management service apparatus, and information about position of the neighbor management service apparatus; and
the information about the at least one neighbor management service apparatus is used to select a channel to be occupied by the information service apparatus.

4. The method according to claim 1, further comprising:
transmitting a measurement request message to at least one information service apparatus or management service apparatus registered to the management apparatus; and
receiving a measurement report message from the at least one information service management or management service apparatus,
wherein the measurement request message includes information about a measurement type and a measurement request according to the measurement type; and
the measurement type indicates measurement of an interference level, occupied channel information, an average noise power indicator (ANPI), a packet error rate (PER), channel load, neighbor discovery information, and threshold exceed interference load.

5. The method according to claim 4, wherein, when the measurement type indicates measurement of one of the interference level, the ANPI, the PER, and the channel load, the information about the measurement request includes information about a target channel or frequency for the measurement.

6. The method according to claim 4, wherein, when the measurement type indicates measurement of the neighbor discovery, the information about the measurement request includes information about an ID of a neighbor CM and an occupied channel.

7. The method according to claim 4, wherein, when the measurement type indicates measurement of the threshold exceed interference load, information about the measurement request comprises information about a threshold and a target channel or frequency for the measurement.

8. The method according to claim 4, wherein the measurement request message and the measurement report message includes an ID of the information service apparatus.

9. The method according to claim 1, further comprising allocating a channel of the management service apparatus based on information about the occupied channels, contained in the occupied channel query response message.

10. The method according to claim 1, wherein:
the ID of the information service apparatus is a unique value of each information service apparatus allocated by a server; and
wherein the method further comprises, upon receiving information about the information service apparatus registered to the management apparatus from another management apparatus, transmitting a response message including an ID of the information service apparatus registered to the management apparatus to the another management apparatus.

11. A method for acquiring information about an occupied channel of an apparatus (hereinafter, an information service apparatus) subscribing an information service for channel allocation for an apparatus (hereinafter, a management service apparatus) subscribing a management service in a television white space (TVWS) network in which the information service apparatus and the management service apparatus coexist, the method being performed by an information service apparatus, the method comprising:
receiving an occupied channel query request message for query of information about one or more channels (hereinafter, occupied channels) occupied by the information service apparatus, from a management apparatus; and
transmitting an occupied channel query response message including information about the occupied channels, to the management apparatus,
wherein the occupied channel query request message includes an identification (ID) of the information service apparatus and information about a measurement period of the occupied channels; and
the information service apparatus and the management service apparatus are TVWS apparatuses.

12. The method according to claim 11, wherein the occupied channel query response message includes an ID of the information service apparatus, the number of the occupied channels, a list of the occupied channels, a maximum power list of each of the occupied channels, and a channel busy time of each of the occupied channels.

13. The method according to claim 11, further comprising:
transmitting a neighbor report request message for requesting information about at least one neighbor management service apparatus, to the management apparatus; and
receiving a neighbor report response message including information about the at least one neighbor management service apparatus, acquired via measurement report from the at least one neighbor management service apparatus, from the management apparatus,
wherein the information about the at least one neighbor management service apparatus comprises at least one of information about a channel or frequency occupied by the at least one neighbor management service apparatus, and information about position of the neighbor management service apparatus; and
the information about the at least one neighbor management service apparatus is used to select a channel to be occupied by the information service apparatus.

14. The method according to claim 11, wherein:
the ID of the information service apparatus is a unique value of each information service apparatus allocated by a server; and
upon receiving a request for information about the information service apparatus registered to the management apparatus from another management apparatus, a response message comprising an ID of the information service apparatus is transmitted by the management apparatus to the another management apparatus.

15. The method according to claim 12, wherein:
the ID of the information service apparatus is a unique value of each information service apparatus allocated by a server; and
upon receiving a request for information about the information service apparatus registered to the management apparatus from another management apparatus, a response message comprising an ID of the information service apparatus is transmitted by the management apparatus to the another management apparatus.

16. The method according to claim 2, wherein:
the ID of the information service apparatus is a unique value of each information service apparatus allocated by a server; and
wherein the method further comprises, upon receiving information about the information service apparatus registered to the management apparatus from another management apparatus, transmitting a response message including an ID of the information service apparatus registered to the management apparatus to the another management apparatus.

17. The method according to claim 8, wherein:
the ID of the information service apparatus is a unique value of each information service apparatus allocated by a server; and
wherein the method further comprises, upon receiving information about the information service apparatus registered to the management apparatus from another management apparatus, transmitting a response message including an ID of the information service apparatus registered to the management apparatus to the another management apparatus.
